(19) United States
(12) Patent Application Publication
(10) Pub. No.: US 2026/0343605 A1
(43) Pub. Date: Oct. 29, 2026

(54) ACCESS POINT, WIRELESS TERMINAL APPARATUS, AND COMMUNICATION SYSTEM

(71) Applicant: NTT, Inc., Tokyo (JP)

(72) Inventors: Akira KISHIDA, Musashino-shi (JP); Kengo NAGATA, Musashino-shi (JP); Yusuke ASAI, Musashino-shi (JP); Yasushi TAKATORI, Musashino-shi (JP)

(73) Assignee: NTT, Inc., Tokyo (JP)

(21) Appl. No.: 18/995,875

(22) PCT Filed: Aug. 10, 2022
(86) PCT No.: PCT/JP2022/030557

§ 371 Date: Jan. 17, 2025

(51) Int. Cl. H04W 74/0816; H04W 76/15

(52) U.S. Cl. CPC H04W 74/0816; H04W 76/15

(57) ABSTRACT

An access point of an embodiment includes a first wireless signal processing unit and a first management unit. The first management unit establishes a first link with a first wireless terminal apparatus and the second link with the second wireless terminal apparatus using a first wireless signal processing unit, and sets a service period in a first cycle. The first management unit provides a transmission opportunity for data to the first wireless terminal apparatus, and suppresses or prohibits transmission of data by the second wireless terminal apparatus within a service period, and sets a transmission suppression period for suppressing or prohibiting transmission of data by the first wireless terminal apparatus outside the service period.

### TECHNICAL FIELD

Embodiments relate to an access point, a wireless terminal apparatus, and a communication system.

### BACKGROUND ART

A wireless local area network (LAN) is known as a communication system that wirelessly connects a base station and a wireless terminal apparatus. The wireless terminal apparatus can access a network via an access point in a communication area using a wireless LAN.

### CITATION LIST

### Non Patent Literature

[NPL 1] IEEE P802.11be™/D1.5, “35.9 Restricted TWT (r-TWT)”, Mar. 18, 2022

### SUMMARY OF INVENTION

### Technical Problem

A problem is to suppress delay of traffic transmitted wirelessly.

### Solution to Problem

An access point of an embodiment includes a first wireless signal processing unit and a first management unit. The first management unit establishes a first link with the first wireless terminal apparatus and a second link with the second wireless terminal apparatus using the first wireless signal processing unit, and sets a service period in a first cycle. The first management unit provides a transmission opportunity for data to the first wireless terminal apparatus, and suppresses or prohibits transmission of data by the second wireless terminal apparatus within a service period, and sets a transmission suppression period for suppressing or prohibiting transmission of data by the first wireless terminal apparatus outside the service period.

### Advantageous Effects of Invention

An access point of an embodiment can suppress delay of traffic transmitted wirelessly.

### BRIEF DESCRIPTION OF DRAWINGS

FIG. 1 is a block diagram illustrating an example of a configuration of a communication system according to a first embodiment.

FIG. 2 is a table illustrating an example of link management information in an access point included in a communication system according to the first embodiment.

FIG. 3 is a time chart illustrating an overview of an rTWT function of the communication system according to the first embodiment.

FIG. 4 is a block diagram illustrating an example of a hardware configuration of the access point included in the communication system according to the first embodiment.

FIG. 5 is a block diagram illustrating an example of a hardware configuration of a wireless terminal apparatus included in the communication system according to the first embodiment.

FIG. 6 is a block diagram illustrating an example of a functional configuration of the access point included in the communication system according to the first embodiment.

FIG. 7 is a block diagram illustrating an example of a functional configuration of the wireless terminal apparatus included in the communication system according to the first embodiment.

FIG. 8 is a block diagram illustrating an example of a configuration of a channel access function of the access point included in the communication system according to the first embodiment.

FIG. 9 is a flowchart illustrating an example of a method for setting up the rTWT function of the communication system according to the first embodiment.

FIG. 10 is a schematic diagram illustrating an example of a format of a beacon frame transmitted by an access point included in the communication system according to the first embodiment.

FIG. 11 is a flowchart illustrating an example of a frame exchange method using the rTWT function of the communication system according to the first embodiment.

FIG. 12 is a time chart illustrating a specific example of a frame exchange method using the rTWT function of the communication system according to the first embodiment.

FIG. 13 is a schematic diagram illustrating an example of a parameter used for setting a transmission suppression period by an access point included in the communication system according to the first embodiment.

FIG. 14 is a block diagram illustrating an example of a functional configuration of an access point included in the communication system according to a second embodiment.

FIG. 15 is a schematic diagram illustrating an example of a format of a transmission prohibition frame transmitted by the access point included in the communication system according to the second embodiment.

FIG. 16 is a flowchart illustrating an example of a frame exchange method using an rTWT function of the communication system according to the second embodiment.

FIG. 17 is a time chart illustrating a specific example of the frame exchange method using the rTWT function of the communication system according to the second embodiment.

FIG. 18 is a block diagram illustrating an example of a functional configuration of an access point included in the communication system according to a third embodiment.

FIG. 19 is a flowchart illustrating an example of a frame exchange method of the communication system provided in the communication system according to the third embodiment.

FIG. 20 is a time chart illustrating a specific example of a frame exchange method using the rTWT function of the communication system according to the third embodiment.

FIG. 21 is a block diagram illustrating an example of a functional configuration of an access point included in a communication system according to a fourth embodiment.

FIG. 22 is a block diagram illustrating an example of a functional configuration of a wireless terminal apparatus included in the communication system according to the fourth embodiment.

FIG. 23 is a flowchart illustrating an example of a frame exchange method using an rTWT function of the communication system according to the fourth embodiment.

FIG. 24 is a time chart illustrating a specific example of a frame exchange method using the rTWT function of the communication system according to the fourth embodiment.

FIG. 25 is a block diagram illustrating an example of a functional configuration of a wireless terminal apparatus included in a communication system according to a fifth embodiment.

FIG. 26 is a flowchart illustrating an example of a frame exchange method of the communication system according to the fifth embodiment.

FIG. 27 is a time chart illustrating a specific example of the frame exchange method of the communication system according to the fifth embodiment.

### DESCRIPTION OF EMBODIMENTS

Embodiments will be described below with reference to the drawings. Each embodiment illustrates an apparatus or method for embodying the technical idea of the invention. The drawings are schematic or conceptual. In the following description, components having substantially the same function and configuration are denoted by the same reference numerals.

### First Embodiment

A communication system 1 according to a first embodiment provides a period for suppressing transmission of traffic other than a period of a service period to a wireless terminal apparatus to which the service period is allocated, the service period being capable of preferentially exchanging traffic requested to be low-delayed. A communication system 1 according to the first embodiment will be described below.

### <1-1> Configuration

### <1-1-1> Overall Configuration of Communication System 1

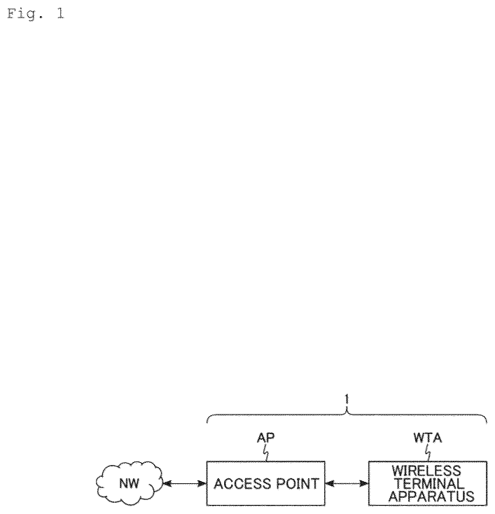

FIG. 1 is a block diagram illustrating an example of a configuration of a communication system 1 according to a first embodiment. As illustrated in FIG. 1, the communication system 1 includes an access point AP and a wireless terminal apparatus WTA.

The access point AP is a base station of a wireless LAN. The access point AP is configured to be capable of wirelessly communicating with the wireless terminal apparatus WTA, and is configured to be capable of communicating with a server (not shown) on a network NW. The access point AP supports the restricted-target wake time (rTWT) function. The rTWT function is a function for allocating a service period in which traffic requiring low delay can be preferentially exchanged to a predetermined wireless terminal apparatus WTA. In the following, such a service period is called an “rTWT service period SP”, and traffic requiring a low delay is called “low delay traffic”.

The wireless terminal apparatus WTA is a wireless terminal such as a smartphone or a personal computer (PC). The wireless terminal apparatus WTA is configured to be able to communicate with a server on a network NW via an access point AP. Hereinafter, the wireless terminal apparatus WTA supporting the rTWT function is called an “extremely high throughput (EHT) terminal STA1”, and the wireless terminal apparatus WTA not supporting the rTWT function is called a “legacy terminal STA2”.

Communication between the access point AP and the wireless terminal apparatus WTA is based on, for example, the IEEE802.11 standard. The IEEE802.11 standard has a wireless communication function based on the open systems interconnection (OSI) reference model. In the OSI reference model, communication functions are divided into seven layers (first layer: physical layer, second layer: data link layer, third layer: network layer, fourth layer: transport layer, fifth layer: session layer, sixth layer: presentation layer, and seventh layer: application layer). The data link layer includes a logical link control (LLC) sublayer and a media access control (MAC) sublayer.

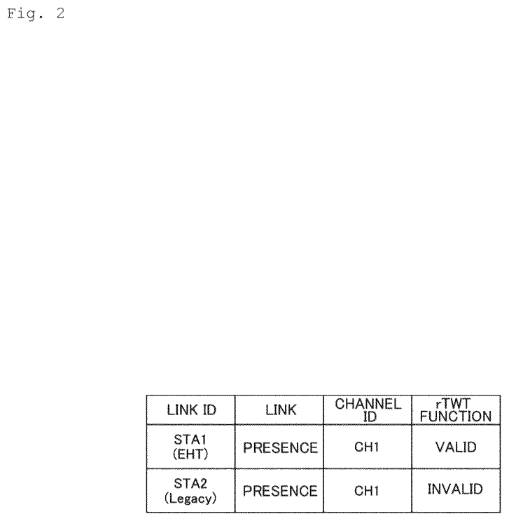

The access point AP manages a plurality of wireless terminal apparatuses WTA wirelessly connected using the link management information. FIG. 2 is a table illustrating an example of link management information in the access point AP according to the first embodiment. As illustrated in FIG. 2, the link management information includes, for example, information on a “link ID”, a “link”, a “channel ID”, and an “rTWT function”.

The item of the “link ID” indicates the identifier of the link associated with the STA function of the access point AP and the wireless terminal apparatus WTA. In this example, the link management information records information on an EHT terminal STA1 and a legacy terminal STA2.

The item of the “link” indicates whether or not a link is established in the associated link ID. In this example, it is shown that the access point AP is in the state of establishing a link with each of the EHT terminal STA1 and the legacy terminal STA2 (FIG. 2: Presence).

The item of the “channel ID” indicates the identifier of the channel used for the link. In this example, a common channel CH1 is allocated to each of the EHT terminal STA1 and the legacy terminal STA2.

The item of the “rTWT function” indicates whether the rTWT function is valid or not. In this example, the rTWT function of the EHT terminal STA1 is valid (FIG. 2: Valid). On the other hand, the rTWT function of the legacy terminal STA2 is invalid (FIG. 2: Invalid).

In the present specification, as described above, the case where the channel CH1 is shared by the EHT terminal STA1 and the legacy terminal STA2, and the access point AP performs wireless communication with the EHT terminal STA1 and the legacy terminal STA2 using the rTWT function will be described.

(Summary of rTWT Function)

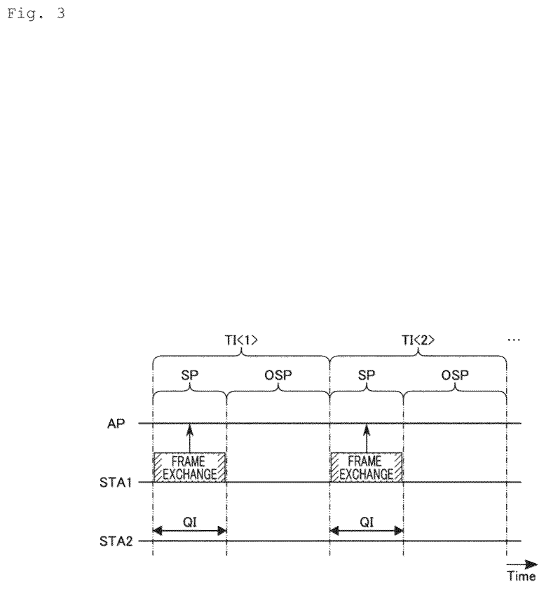

FIG. 3 is a flowchart illustrating an overview of an rTWT function of a communication system 1 according to the first embodiment. As illustrated in FIG. 3, the access point AP using the rTWT function sets a constant period (hereinafter referred to as “TWT period”). FIG. 3 illustrates continuous TWT intervals TI<1> and TI<2> in the TWT period.

Each TWT interval TI corresponds to one period of the TWT period. Each TWT interval TI includes an rTWT service period SP and a period OSP. The period OSP corresponds to a period that does not overlap the rTWT service period SP, that is, a period outside the rTWT service period SP (outside of the rTWT service period). Hereinafter, the start time of the rTWT service period SP is referred to as the “rTWT start time TS”. The rTWT service period SP is determined by the rTWT start time TS and the rTWT continuation period TD. The rTWT continuation period TD indicates the length of the rTWT service period SP starting from the rTWT start time TS. A wireless terminal apparatus WTA can recognize a time based on the rTWT start time TS and the TWT period (TWT interval TI) as the rTWT start time of the next rTWT service period SP. That is, the TWT interval TI corresponds to the interval of the rTWT start time TS of each of the adjacent rTWT service periods SP.

In the rTWT service period SP, the access point AP preferentially gives a frame exchange opportunity to the EHT terminal STA1, and sets a transmission suppression period QI to the legacy terminal STA2. The frame exchange opportunity corresponds to an opportunity to transmit traffic (data) by frame exchange. The transmission suppression period QI corresponds to a period in which transmission of traffic by the legacy terminal STA2 is suppressed. The transmission suppression period QI overlaps with the rTWT service period SP. The transmission suppression period QI is set to the same length as or shorter than the rTWT service period SP. The access point AP can set the rTWT start time TS and the rTWT continuation period TD for each link.

The EHT terminal STA1 transmits, for example, low delay traffic based on reception of a trigger frame within the rTWT service period SP. The access point AP may transmit a trigger frame to the EHT terminal STA1 at the rTWT start time TS. In the rTWT service period SP, the EHT terminal STA1 can preferentially transmit low delay traffic, and can improve latency of the low delay traffic. On the other hand, in the period OSP, each of the EHT terminal STA1 and the legacy terminal STA2 can obtain a frame exchange opportunity. Then, the rTWT function in the first embodiment further sets a period for suppressing frame exchange by the EHT terminal STA1 outside the rTWT service period. An operation will be described later in detail.

It is preferable that the TWT period is set in accordance with the transmission period of the low delay traffic of the wireless terminal apparatus WTA. Initial setting of the rTWT function may be determined in various ways. For example, for the initial setting of the rTWT function, the attributes of traffic such as the occurrence interval of traffic and the amount of data notified from the application generating the low delay traffic may be used. In this case, the access point AP acquires the attribute of the corresponding traffic by notifying a server on the network NW of the type of the traffic. Then, the access point AP determines initial setting of the rTWT function based on the acquired attribute of the traffic.

### <1-1-2> Hardware Configuration of Communication System 1

### (Hardware Configuration of Access Point AP)

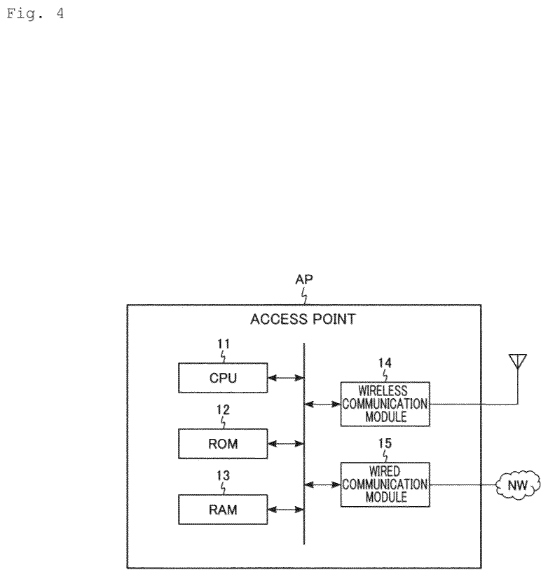

FIG. 4 is a block diagram illustrating an example of a hardware configuration of the access point AP included in the communication system 1 according to the first embodiment. As illustrated in FIG. 4, the access point AP includes, for example, a central processing unit (CPU) 11, a read only memory (ROM) 12, a random access memory (RAM) 13, a wireless communication module 14, and a wired communication module 15.

The CPU 11 is an integrated circuit capable of executing various programs and controls the overall operation of the access point AP. The ROM 12 is a non-volatile semiconductor memory and stores programs, control data, and the like for controlling the access point AP. The RAM 13 is, for example, a volatile semiconductor memory and is used as a working area of the CPU 11. The wireless communication module 14 is a circuit used for transmitting and receiving data by wireless signals, and is configured to be connectable to an antenna. The wired communication module 15 is a circuit used for transmitting and receiving data by wired signals, and is configured to be connectable to the network NW. Note that the access point AP may have other hardware configurations. For example, when the access point AP is wirelessly connected to the network NW, the wired communication module 15 may be omitted from the access point AP.

### (Hardware Configuration of Wireless Terminal Apparatus WTA)

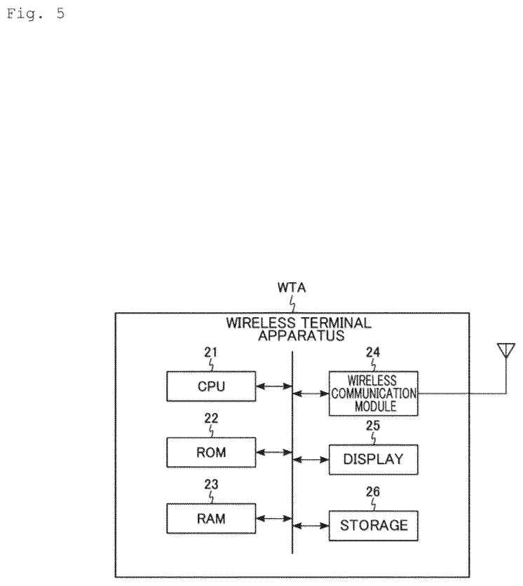

FIG. 5 is a block diagram illustrating an example of the hardware configuration of the wireless terminal apparatus WTA included in the communication system 1 according to the first embodiment. As illustrated in FIG. 5, the wireless terminal apparatus WTA includes a CPU 21, a ROM 22, a RAM 23, a wireless communication module 24, a display 25, and a storage 26, for example.

The CPU 21 is an integrated circuit capable of executing various programs and controls the overall operation of the wireless terminal apparatus WTA. The ROM 22 is a non-volatile semiconductor memory and stores programs, control data, and the like for controlling the wireless terminal apparatus WTA. The RAM 23 is, for example, a volatile semiconductor memory and is used as a working area of the CPU 21. The wireless communication module 24 is a circuit used for transmitting and receiving data by wireless signals, and is configured to be connectable to an antenna. The display 25 displays, for example, a GUI (Graphical User Interface) corresponding to application software. The display 25 may have a function as an input interface for the wireless terminal apparatus WTA. The storage 26 is a non-volatile storage device, and stores, for example, system software of the wireless terminal apparatus WTA. Note that the wireless terminal apparatus WTA may have other hardware configurations. For example, when the wireless terminal apparatus WTA is the Internet of Things (IoT) terminal or the like, the display 25 may be omitted from the wireless terminal apparatus WTA.

### <1-1-3> Functional Configuration of Communication System 1

### (Functional Configuration of Access Point AP)

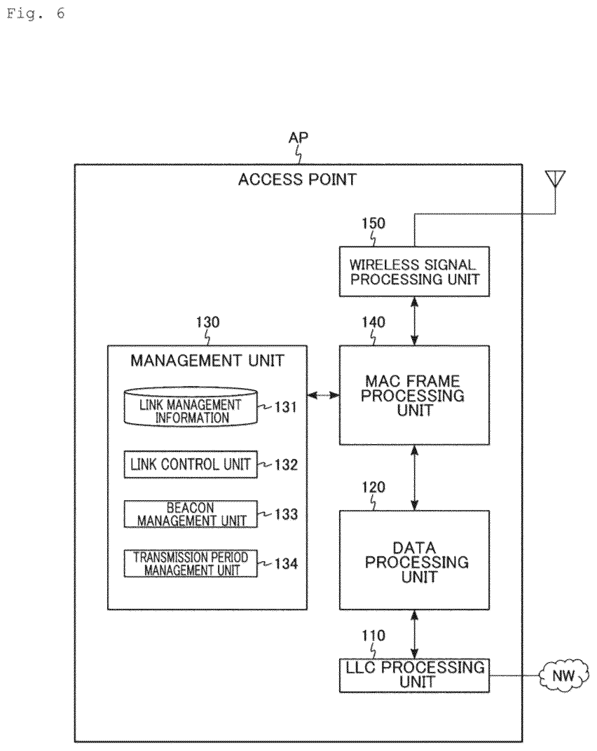

FIG. 6 is a block diagram illustrating an example of a functional configuration of the access point AP included in the communication system 1 according to the first embodiment. As illustrated in FIG. 6, the access point AP functions as a computer that includes an LLC processing unit 110, a data processing unit 120, a management unit 130, a MAC frame processing unit 140, and a wireless signal processing unit 150. The LLC processing unit 110 is a functional block that executes processing corresponding to the LLC sublayer of second layer and third layer to seventh layer. The data processing unit 120, the management unit 130, and the MAC frame processing unit 140 are functional blocks that execute processing corresponding to the MAC sublayer of second layer. The wireless signal processing unit 150 is a functional block that executes processing corresponding to the MAC sublayer of second layer and first layer.

The LLC processing unit 110 also adds a destination service access point (DSAP) header and a source service access point (SSAP) header and so forth to data input from a higher layer, for example, thereby forming LLC packets. Then, the LLC processing unit 110 inputs the generated LLC packet to the data processing unit 120. In addition, the LLC processing unit 110 extracts data from the LLC packet input from the data processing unit 120. Further, the LLC processing unit 110 transmits the extracted data to a network NW.

The data processing unit 120 adds a MAC header to the LLC packet input from LLC processing unit 110 to generate a MAC frame. Then, the data processing unit 120 inputs the generated MAC frame to the MAC frame processing unit 140. In addition, the data processing unit 120 extracts the LLC packet from the MAC frame input from the MAC frame processing unit 140. Then, the data processing unit 120 inputs the extracted LLC packet to the LLC processing unit 110. The MAC frame including data is also called the “data frame”.

The management unit 130 manages the state of the link between the access point AP and the wireless terminal apparatus WTA. Between the management unit 130 and the MAC frame processing unit 140, a MAC frame including management information on a link, an rTWT function or the like is input and output. The MAC frame including the management information is also called the “management frame”. The management unit 130 includes, for example, link management information 131, a link control unit 132, a beacon management unit 133, and a transmission period management unit 134.

The link management information 131 includes information on a link between the access point AP and a wireless terminal apparatus WTA wirelessly connected. The link management information 131 includes, for example, information illustrated in FIG. 2. In addition, the link management information 131 may include information on setting of the rTWT function such as the rTWT start time TS and the rTWT continuation period TD.

The link control unit 132 controls establishment of a link between the access point AP and the wireless terminal apparatus WTA. For example, the link control unit 132 executes association processing and subsequent authentication processing in response to a connection request from the wireless terminal apparatus WTA. The link control unit 132 can control a state of a link established with the wireless terminal apparatus WTA.

The beacon management unit 133 manages information transmitted as a beacon by the access point AP. Specifically, the beacon management unit 133 periodically generates, for example, a management frame including management information on an rTWT function. Then, the beacon management unit 133 inputs the generated management frame to the MAC frame processing unit 140. That is, the beacon management unit 133 notifies the wireless terminal apparatus WTA of the rTWT start time TS and the rTWT continuation period TD. The management frame generated by the beacon management unit 133 is also called a “beacon frame”.

The transmission period management unit 134 manages a transmission suppression period RP. The transmission suppression period RP corresponds to a period in which frame exchange by the EHT terminal STA1 is suppressed when the rTWT function is used. The transmission period management unit 134 sets, for example, the transmission suppression period RP after the rTWT service period SP of each TWT interval TI.

The MAC frame processing unit 140 inputs the MAC frame input from the data processing unit 120 or the management unit 130 to the wireless signal processing unit 150 corresponding to a link associated with the MAC frame. Also, the MAC frame processing unit 140 inputs the MAC frame input from the wireless signal processing unit 150 to the data processing unit 120 or the management unit 130 depending on the type of the MAC frame. Specifically, the MAC frame processing unit 140 inputs the MAC frame to the data processing unit 120 when the MAC frame is a data frame. In a case where the MAC frame is a management frame, the MAC frame processing unit 140 inputs the MAC frame to the management unit 130.

The wireless signal processing unit 150 executes carrier sense. The carrier sense is processing for confirming the state of the channel. In a case where the channel is in a busy state, the wireless signal processing unit 150 continues carrier sensing. In a case where the channel is in an idle state, the wireless signal processing unit 150 adds a preamble and the like to the MAC frame input from the MAC frame processing unit 140 to generate a wireless frame. Then, each of the wireless signal processing unit 150 converts the generated wireless frame into a wireless signal (wireless medium), and radiates (transmits) the converted wireless signal via an antenna. Examples of processing of converting the wireless frame into the wireless signal include, for example, convolution encoding processing, interleaving processing, subcarrier modulation processing, inverse fast Fourier Transform processing, orthogonal frequency division multiplexing (OFDM) modulation processing, and frequency conversion processing. In addition, the wireless signal processing unit 150 converts the wireless signal received via the antenna into a wireless frame. Examples of processing of converting the wireless signal into the wireless frame include, for example, frequency conversion processing, OFDM demodulation processing, fast Fourier Transform processing, subcarrier demodulation processing, deinterleaving processing, and Viterbi decoding processing. Moreover, the wireless signal processing unit 150 extracts the MAC frame from the converted radio frame, and inputs the extracted MAC frame to the MAC frame processing unit 140. The wireless signal processing unit 150 may be referred to as an “STA function”. The access point AP may include a plurality of wireless signal processing units 150 each handling a different channel CH.

### (Functional Configuration of Wireless Terminal Apparatus WTA)

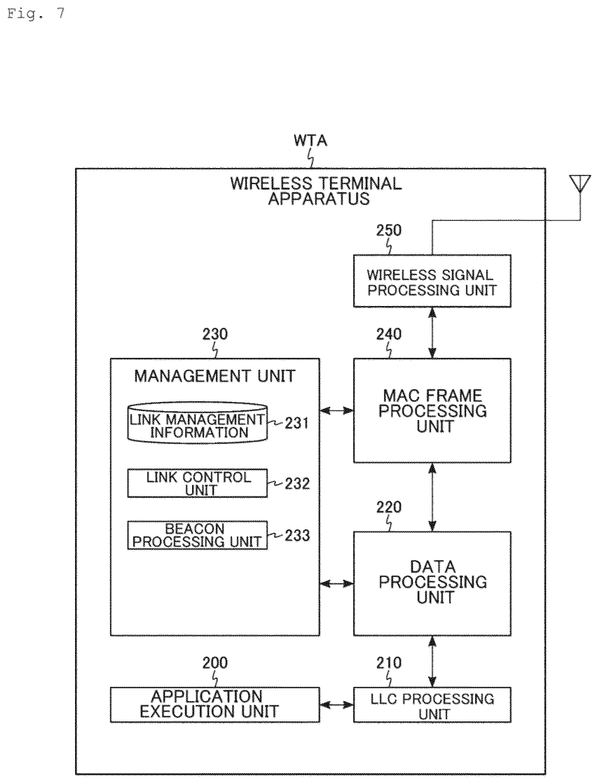

FIG. 7 is a block diagram illustrating an example of the functional configuration of the wireless terminal apparatus WTA included in the communication system 1 according to the first embodiment. As illustrated in FIG. 7, the wireless terminal apparatus WTA includes, for example, an application execution unit 200, an LLC processing unit 210, a data processing unit 220, a management unit 230, a MAC frame processing unit 240, and a wireless signal processing unit 250. The application execution unit 200 is a functional block that executes processing corresponding to seventh layer. The LLC processing unit 210 is a functional block that executes processing corresponding to the LLC sublayer of second layer and third layer to sixth layer. The data processing unit 220, the management unit 230, and the MAC frame processing unit 240 are functional blocks that execute processing corresponding to the MAC sublayer of second layer. The wireless signal processing unit 250 is a functional block that executes processing corresponding to the MAC sublayer of second layer and first layer.

The application execution unit 200 executes an application based on data input from the LLC processing unit 210. In addition, the application execution unit 200 inputs data to the LLC processing unit 210. For example, the application execution unit 200 can display information regarding the application on the display 25. In addition, the application execution unit 200 can work based on an operation of the input interface.

For example, the LLC processing unit 210 adds the DSAP header, the SSAP header, and the like to the data input from the application execution unit 200 to generate an LLC packet. Then, the LLC processing unit 210 inputs the generated LLC packet to the data processing unit 220. In addition, the LLC processing unit 210 extracts data from the LLC packet input from the data processing unit 120. Then, the LLC processing unit 210 inputs the extracted data to the application execution unit 200.

The data processing unit 220 adds the MAC header to the LLC packet input from the LLC processing unit 210 to generate a MAC frame. Then, the data processing unit 220 inputs the generated MAC frame to the MAC frame processing unit 240. In addition, the data processing unit 220 extracts LLC packets from the MAC frame input from the MAC frame processing unit 240. Then, the data processing unit 220 inputs the extracted LLC packet to the LLC processing unit 210.

The management unit 230 manages the state of the link between the access point AP and the wireless terminal apparatus WTA. Between the management unit 230 and the MAC frame processing unit 240, a MAC frame including management information on a link, an rTWT function or the like is input and output. The management unit 230 includes, for example, link management information 231, a link control unit 232, and a beacon processing unit 233.

The link management information 231 includes information on a link between the wireless terminal apparatus WTA and an access point AP wirelessly connected. The link management information 231 may also include information on setting of the rTWT function (such as rTWT start time TS and rTWT continuation period TD).

The link control unit 232 controls establishment of a link between the access point AP and the wireless terminal apparatus WTA. For example, the link control unit 232 executes association processing and subsequent authentication processing when transmitting a connection request to the access point AP. The link control unit 232 can control a state of a link established with the access point AP.

The beacon processing unit 233 processes information included in the beacon received from the access point AP. Specifically, the beacon processing unit 233 extracts management information on the rTWT function from a beacon frame input from the MAC frame processing unit 240. Then, the beacon processing unit 233 associates, for example, the rTWT start time TS and the rTWT continuation period TD among pieces of management information on the extracted rTWT function with a link to which the rTWT function is applied, for example, it is recorded in the link management information 231. In other words, the beacon processing unit 233 extracts a period (rTWT service period SP) for transmitting low delay traffic from the received beacon, and reflects the extracted period on the link management information 231. The beacon processing unit 233 may notify the data processing unit 220 of management information on the rTWT function.

The MAC frame processing unit 240 inputs the MAC frame input from the data processing unit 220 or the management unit 230 to the wireless signal processing unit 250 corresponding to a link associated with the MAC frame. In addition, the MAC frame processing unit 240 inputs the MAC frame input from the wireless signal processing unit 250 to the data processing unit 220, the management unit 230, or the wireless signal processing unit 250, depending on the type of the MAC frame. Specifically, the MAC frame processing unit 240 inputs the MAC frame to the data processing unit 220 when the MAC frame is a data frame. In a case where the MAC frame is a management frame, a MAC frame processing unit 240 inputs the MAC frame to the management unit 230. For example, in a case where the MAC frame is a beacon frame, the MAC frame processing unit 240 inputs the beacon frame to the beacon processing unit 233. In a case where the MAC frame is a trigger frame, the MAC frame processing unit 240 outputs corresponding data to the wireless signal processing unit 250. The trigger frame is a frame used when the access point AP requests the wireless terminal apparatus WTA to transmit traffic.

The wireless signal processing unit 250 executes carrier sense processing. In a case where the channel is in a busy state, the wireless signal processing unit 250 continues carrier sense processing. In a case where the channel is in an idle state, the wireless signal processing unit 250 adds a preamble and the like to the MAC frame input from the MAC frame processing unit 240 to generate a wireless frame. Then, each of the wireless signal processing unit 250 converts the generated wireless frame into a wireless signal (wireless medium), and radiates (transmits) the converted wireless signal via an antenna. Examples of processing of converting the wireless frame into the wireless signal include, for example, convolution encoding processing, interleaving processing, subcarrier modulation processing, inverse fast Fourier Transform processing, OFDM modulation processing, and frequency conversion processing. In addition, the wireless signal processing unit 250 converts the wireless signal received via the antenna into a wireless frame. Examples of processing of converting the wireless signal into the wireless frame include, for example, frequency conversion processing, OFDM demodulation processing, fast Fourier Transform processing, subcarrier demodulation processing, deinterleaving processing, and Viterbi decoding processing. Moreover, the wireless signal processing unit 250 extracts the MAC frame from the converted radio frame, and inputs the extracted MAC frame to the MAC frame processing unit 240. The wireless signal processing unit 250 may be referred to as an “STA function”. The wireless terminal apparatus WTA may include a plurality of wireless signal processing units 250 each handling a different channel CH.

### (Configuration of Channel Access Function of Access Point AP)

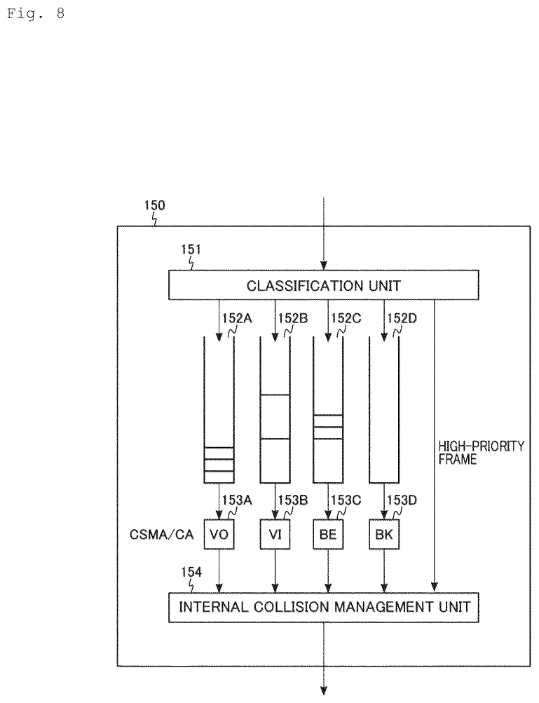

FIG. 8 is a block diagram illustrating an example of a configuration of channel access function of the access point AP according to the first embodiment. As illustrated in FIG. 6, the wireless signal processing unit 150 of the access point. AP includes, for example, a classification unit 151, queues 152A, 152B, 152C and 152D, carrier sense execution units 153A, 153B, 153C and 153D, and an internal collision management unit 154.

In a case where the MAC frame input from the MAC frame processing unit 240 is a data frame, the classification unit 151 classifies the data frame into a plurality of access categories based on a traffic identifier (TID) included in the MAC header. Traffic identifiers include, for example, “Voice (VO)”, “Video (VI)”, “Best Effort (BE)”, “Background (BK)”, and “Low Latency (LL)”. Then, the classification unit 151 inputs the data frame to the corresponding the queue 152 among the plurality of queues 152A, 152B, 152C, and 152D. In this example, the classification unit 151 inputs data frames corresponding to access categories VO, VI, BE, and BK to queues 152A, 152B, 152C, and 152D, respectively. In a case where the MAC frame input from the MAC frame processing unit 140 is a high-priority frame such as a trigger frame, the classification unit 151 inputs the high-priority frame to the internal collision management unit 154, for example, without passing through the queue 152.

Each of the plurality of queues 152A, 1528, 152C, and 152D buffers an input data frame. In this example, the plurality of queues 152A, 152B, 152C, and 152D buffer data frames corresponding to access categories VO, VI, BE, and BK, respectively.

Each of the plurality of carrier sense execution units 153A, 153B, 153C, and 153D is associated with a plurality of queues 152A, 152B, 152C, and 152D, respectively. Each of the plurality of carrier sense execution units 153A, 153B, 153C, and 153D executes carrier sense based on Carrier Sense Multiple Access with Collision Avoidance (CSMA/CA) according to preset access parameters. The Access parameters are set for each access category, and are set, for example, so that wireless signal transmission is prioritized in the order of “VO”, “VI”, “BE”, and “BK”. Each of the plurality of carrier sense execution units 153A, 153B, 153C, and 153D acquires the right to transmit a data frame and ends carrier sense in a case where it is determined that the channel is in an idle state for a predetermined period of time. In a case where it is determined that the channel is in a busy state, each of the plurality of carrier sense execution units 153A, 153B, 153C, and 153D stops acquiring the transmission right and ends carrier sense. The carrier sense execution unit 153 which has acquired the transmission right extracts the data frame from the associated queue 152, and outputs the extracted data frame to the internal collision management unit 154.

In a case where the internal collision management unit 154 prevents transmission collision in a case where the plurality of carrier sense execution units 153 acquire transmission rights at the same time. Specifically, in a case where a plurality of data frames are simultaneously input, the internal collision management unit 154 preferentially outputs a data frame of an access category with high priority. The data frame output from the internal collision management unit 154 is converted into a wireless frame and transmitted via an antenna.

When a high-priority frame such as a trigger frame is input, the wireless signal processing unit 150 performs carrier sensing and transmits a wireless signal including the high-priority frame via an antenna. Since carrier sensing is executed on high-priority frames without going through the queue 152, they can be processed with lower delay than other traffic. The wireless signal processing unit 150 may temporarily stop the carrier sense of the other queue 152 in a case where the high priority frame is transmitted. In addition, the wireless signal processing unit 150 may generate a trigger frame based on the rTWT start time TS notified from the management unit 130.

As the access parameters used in the carrier sense, contention windows (CW) min, CWmax, arbitration inter frame space (AIFS), and a transmission opportunity (TXOP) limit are used, for example. The contention window is a parameter used for determining a transmission waiting time for avoiding a collision. CWmin and CWmax indicate a minimum value and a maximum value of the contention window respectively. An arbitration inter frame space (AIFS) indicates a fixed transmission waiting time set for each access category for collision avoidance control having a priority control function. The TXOP corresponds to the occupancy time of the channel. TXOPLimit indicates the upper limit value of TXOP. The shorter the CWmin and the CWmax, the easier it is for the queue 152 to obtain the right to transmit. The priority of the queue 152 becomes higher as the AIFS becomes smaller. The amount of data transmitted with one transmission right increases as the value of TXOPLimit increases.

The configuration regarding the channel access function of the wireless terminal apparatus WTA is equivalent to the configuration regarding the channel access function of the access point AP. Although a channel access function is implemented in the wireless signal processing unit 150 in the present specification, the channel access function may be implemented in the MAC frame processing unit 140. The access parameters may be called enhanced distributed channel access (EDCA) parameters.

### <1-2> Operation

<1-2-1> Method for Setting Up rTWT Function

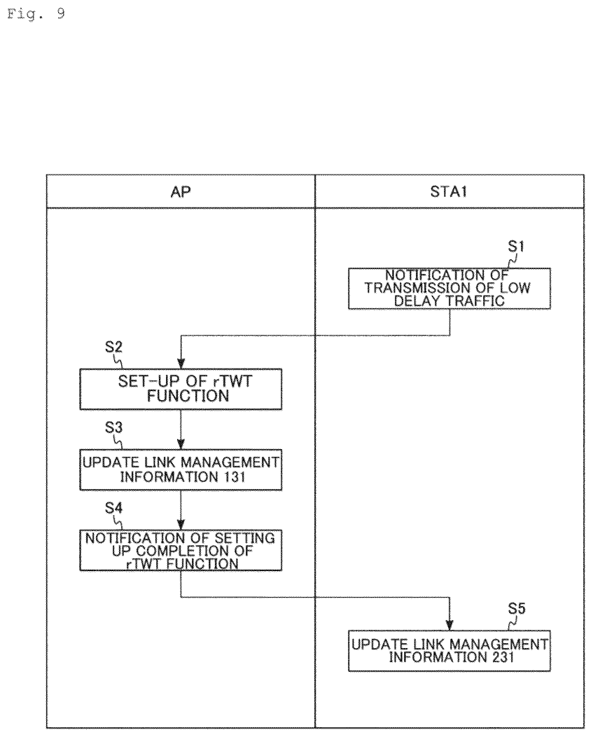

FIG. 9 is a flowchart illustrating an example of a method for setting up the rTWT function of the communication system 1 according to the first embodiment. A method for setting up the rTWT function will be described below with reference to FIG. 9. Setting up of the rTWT function is executed, for example, by transmitting and receiving a management frame between the management unit 130 of the access point AP and the management unit 230 of the wireless terminal apparatus WTA.

First, the EHT terminal STA1 notifies the access point AP of transmission of low delay traffic (S1). At this time, the EHT terminal STA1 also transmits, for example, information on a generation period of low delay traffic to the access point AP.

When the transmission of low delay traffic is notified from the EHT terminal STA1, the access point AP sets up the rTWT function (S2). In the setting up of the rTWT function, the management unit 130 sets, for example, the rTWT start time TS, rTWT continuation period TD, and the TWT cycle in accordance with the generation period of low-latency traffic. The access point AP may acquire the low-latency traffic generation period using any method. For example, the access point AP may acquire information on a data generation period set in an application for generating low delay traffic from the wireless terminal apparatus WTA, and use the information for setting up the rTWT function.

When the setting up of the rTWT function is completed, the access point AP updates the link management information 131 based on the established setting of the rTWT function (S3).

When the update of the link management information 131 is completed, the access point AP notifies the wireless terminal apparatus WTA of the setting up completion of the rTWT function (S4). At this time, the access point AP also transmits the setting of the rTWT function (for example, the rTWT service period SP or the like) to the wireless terminal apparatus WTA.

When receiving the notification that setting up of the rTWT function is completed from the access point AP, the wireless terminal apparatus WTA updates the link management information 231 based on the notified setting of the rTWT function (S5). Thus, the link management information is updated in both the access point AP and the wireless terminal apparatus WTA, and the setting up of the rTWT function is completed. Thereafter, the access point AP and the wireless terminal apparatus WTA can perform data communication using the rTWT function.

The setting up of the rTWT function may be executed when the link is established. The change of the setting of the rTWT function may be executed initiatively by the access point AP or by the wireless terminal, apparatus WTA. The timing at which the access point AP acquires information (such as a generation period of low delay traffic) of the wireless terminal apparatus WTA used for setting the rTWT function is not particularly limited. The access point AP may notify the completion of setting up of the rTWT function by a beacon. That is, the access point AP may notify the wireless terminal apparatus WTA of the setting of the rTWT function using the beacon.

### (Format of Beacon Signal)

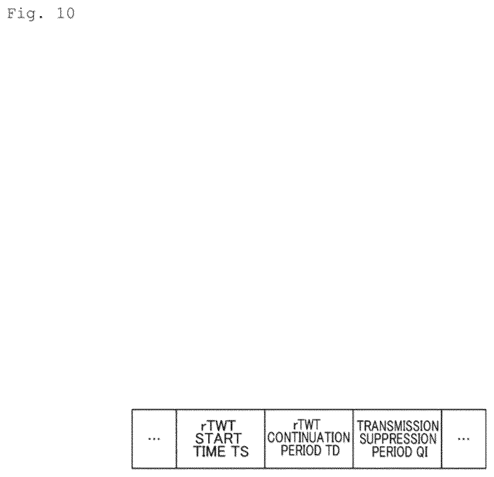

FIG. 10 is a schematic diagram illustrating an example of the format of a beacon frame transmitted by the access point AP included in the communication system 1 according to the first embodiment. As illustrated in FIG. 10, the beacon frame includes, for example, the rTWT start time TS, the rTWT start time TS, the rTWT continuation period TD, and the transmission suppression period QI as management information used by the rTWT function.

The beacon processing unit 233 of each wireless terminal apparatus WTA acquires the rTWT start time TS, the rTWT continuation period TD, and the transmission suppression period QI when receiving a beacon, and notifies the wireless signal processing unit 250 of the result. Thus, the access point AP can spontaneously suppress transmission of uplink data within the rTWT service period SP to a legacy terminal STA2 included in a plurality of wireless terminal apparatuses WTA connected by wirelessly. On the other hand, the wireless terminal apparatus WTA (that is, the EHT terminal STA1 outside a member of the rTWT service period SP), to which communication is not allocated within the set rTWT service period SP, can suppress spontaneous transmission within the set rTWT service period SP by receiving a beacon.

The information indicating the transmission suppression period QI included in the beacon frame may be omitted when the rTWT continuation period TD and the transmission suppression period QI have the same length. In this case, the wireless terminal apparatus WTA sets a period indicated by the input rTWT start time TS and the rTWT continuation period TD as a transmission suppression period QI. That is, the wireless signal processing unit 250 of the wireless terminal apparatus WTA may suppress transmission of traffic during the rTWT service period SP based on the rTWT start time TS and the rTWT continuation period TD.

In addition, the beacon frame may store management information used in the rTWT function for each identifier AID of the wireless terminal apparatus WTA. The wireless terminal apparatus WTA can refer to the AID and determine whether the management information is for its own station. In addition, the access point AP may manage management information used in the rTWT function for each group of the wireless terminal apparatuses WTA. In this case, the access point AP transmits a beacon including information on a set of an identifier of a group of wireless terminal apparatuses WTA sharing the management information and rTWT setting associated with the group.

### <1-2-2> Frame Exchange Method

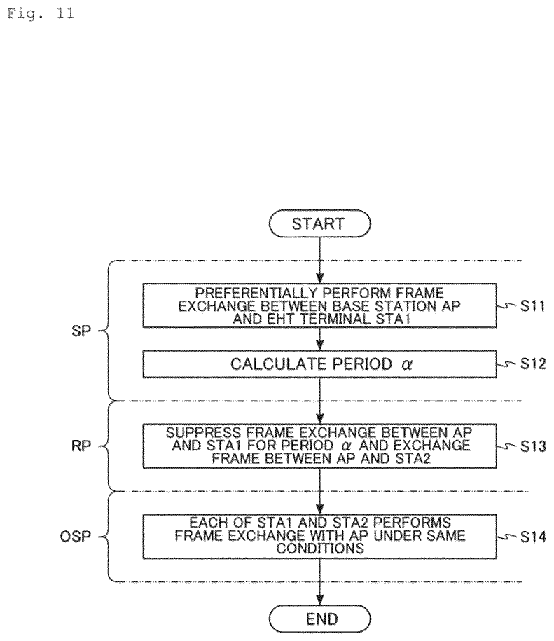

FIG. 11 is a flowchart illustrating an example of a frame exchange method using the rTWT function of the communication system 1 according to the first embodiment. Hereinafter, the frame exchange method using the rTWT function of the communication system 1 according to the first embodiment will be described with reference to FIG. 11 focusing on one TWT interval TI.

When the rTWT service period SP starts (starts), frame exchange is preferentially executed between the access point AP and the EHT terminal STA1 (S11). In the rTWT service period SP, the transmission of traffic of the legacy terminal STA2 is suppressed or prohibited because the transmission suppression period QI is set. The access point AP may record a transmission period (up/down/bidirectional) used by the EHT terminal STA1 during the rTWT service period SP.

When the frame exchange in the rTWT service period SP is completed, the access point AP calculates a period α (S12). The period α is calculated, for example, based on information on the transmission period recorded in S11. A detailed example of the method for calculating the period α will be described later.

When the rTWT service period SP ends, the transmission suppression period RP starts, frame exchange between the access point AP and the EHT terminal STA1 is suppressed for the period α, and frame exchange is performed between the access point AP and the legacy terminal STA2 (S13),

When the transmission suppression period RP ends, the period OSP starts. Then, each of the EHT terminal STA1 and the legacy terminal STA2 executes frame exchange with the access point AP under similar conditions (S14). When the period OSP ends (ends), the access point AP completes the series of processing procedures illustrated in FIG. 11, and starts the processing of the next rTWT service period SP.

### (Specific Example of Frame Exchange Method)

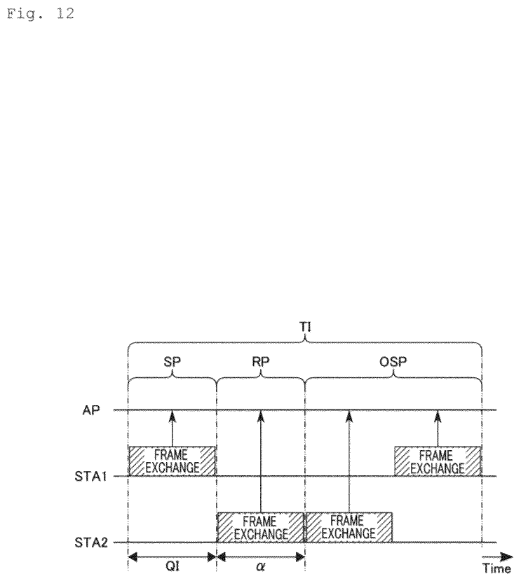

FIG. 12 is a time chart illustrating a specific example of a frame exchange method using the rTWT function of the communication system 1 according to the first embodiment. FIG. 12 illustrates the operation of each of the access point AP, the EHT terminal STA1, and the legacy terminal STA2 in one TWT interval TI. As illustrated in FIG. 12, in the TWT interval TI, for example, the rTWT service period SP, the transmission suppression period RP, and the period OSP are arranged in this order.

In the rTWT service period SP, frame exchange is executed between the EHT terminal STA1 and the access point AP. That is, in the rTWT service period SP, the EHT terminal STA1 may transmit low delay traffic to the access point AP. In addition, the transmission suppression period QI is set to overlap the entire rTWT service period SP. Thus, in the rTWT service period SP, frame exchange between the legacy terminal STA2 and the access point AP is suppressed or prohibited, and the frame exchange between the EHT terminal STA1 and the access point AP is prioritized.

The length of the transmission suppression period RP corresponds to a period α calculated by the access point AP. In the transmission suppression period RP, the frame exchange between the EHT terminal STA1 and the access point AP is suppressed or prohibited. On the other hand, in the transmission suppression period RP, frame exchange between the legacy terminal STA2 and the access point AP is possible. Thus, in the transmission suppression period RP, the frame exchange between the legacy terminal STA2 and the access point AP is prioritized.

In the period OSP, the frame exchange between the EHT terminal STA1 and the access point AP and the frame exchange between the legacy terminal STA2 and the access point AP are performed according to an acquisition order of transmission rights according to a predetermined access parameter. In the period OSP of this example, the frame exchange is executed in the order of the legacy terminal STA2 and the EHT terminal STA1, but the order of frame exchange of each of the EHT terminal STA1 and the legacy terminal STA2 can be changed based on the acquisition order of the transmission right and the traffic amount of each wireless terminal apparatus WTA.

The transmission suppression period RP may be arranged to divide the period OSP. The period OSP may be associated with a period outside the rTWT service period SP and outside the transmission suppression period RP.

### (Setting Method of Transmission Suppression Period)

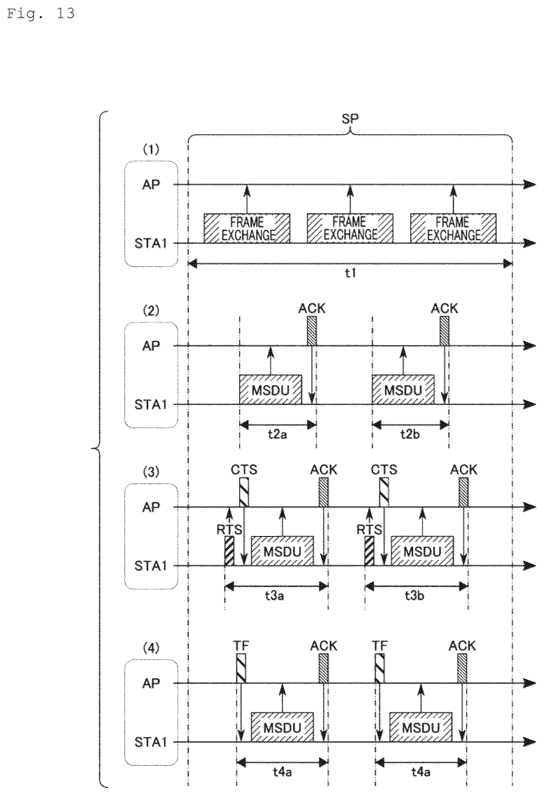

FIG. 13 is a schematic diagram illustrating an example of a parameter used for setting the transmission suppression period RP by the access point AP included in the communication system 1 according to the first embodiment. Each of (1) to (4) in FIG. 13 shows the operation of the access point AP and the EHT terminal STA1 in the rTWT service period SP corresponding to the condition used for calculating the period α. The access point AP sets the length (period α) of the transmission suppression period RP based on the length of the rTWT service period SP or the length of the period of frame exchange with the EHT terminal. STA1 executed within the rTWT service period SP using any of first to fourth conditions described below.

The first condition will be described with reference to (1) in FIG. 13. In a case of using the first condition, the access point AP calculates a value obtained by multiplying a length t1 of the rTWT service period SP by a predetermined coefficient as a period α. That is, the access point AP using the first condition calculates the “α=t1×β” in the processing of S12. The first condition does not depend on the length or the number of times of a period in which the frame exchange is executed in the rTWT service period SP.

The second condition will be described with reference to (2) in FIG. 13. In a case of using the second condition, the access point AP calculates, as a period α, a value obtained by multiplying the total time required for frame exchange between the access point AP and the EHT terminal STA1 by CSMA/CA by a predetermined coefficient γ in the rTWT service period SP. For example, a time required for frame exchange between the access point AP and the EHT terminal STA1 by the CSMA/CA corresponds to a time t2 from when the EHT terminal STA1 starts transmission of a MAC service data unit (MSDU) including uplink data to the access point AP until when the EHT terminal STA1 receives a confirmation frame ACK indicating successful reception of the MS-DU by the access point AP. MSDU is a unit of data handled in the LLC layer. In a case where two frame exchanges are executed in the rTWT service period SP, the access point AP using the second condition calculates, in the processing of S12, “α=(t2a+t2b)×γ”. That is, the second condition is based on the interval between the transmission start time of the MSDU and the reception completion time of the confirmation frame ACK.

The third condition will be described with reference to (3) in FIG. 13. In a case of using the third condition, the access point AP calculates, as a period α, a value obtained by multiplying a total of time required for frame exchange between the access point AP and the EHT terminal STA1 by CSMA/CA using Request to Send (RTS) and Clear to Send (CTS) by a predetermined coefficient δ in an rTWT service period SP. For example, a time required for frame exchange between the access point AP and the EHT terminal STA1 by the CSMA/CA using RTS and CTS corresponds to a time t3 from the start of transmission of RTS to the access point AP by the EHT terminal STA1 until the access point AP completes transmission of a confirmation frame ACK indicating successful reception of MSDU associated with the RTS. In a case where two frame exchanges are executed in the rTWT service period SP, the access point AP using the third condition calculates, in the processing of S12, “α=(t3a+t3b)×δ”. That is, the third condition is based on the interval between the transmission start time of the RTS and the reception completion time of the confirmation frame ACK.

The fourth condition will be described with reference to (4) in FIG. 13. In a case of using the fourth condition, the access point AP calculates, as a period α, a value obtained by multiplying the total time required for frame exchange between the access point AP and the EHT terminal STA1 by a trigger frame TF by a predetermined coefficient ε in the rTWT service period SP. For example, a time required for frame exchange between the access point AP and the EHT terminal STA1 by the trigger frame TF corresponds to a time t4 from when the access point AP starts transmission of the trigger frame TF to the EHT terminal STA1 until when the access point AP completes transmission of a confirmation frame ACK indicating successful reception of the MSDU associated with the trigger frame. In a case where two frame exchanges are executed in the rTWT service period SP, the access point AP using the fourth condition calculates, in the processing of S12, “α=(t4a+t4b)×ε”. That is, the fourth condition is based on the interval between the transmission start time of the trigger frame TF and the reception completion time of the confirmation frame ACK.

### <1-3> Effects of First Embodiment

According to the communication system 1 according to the first embodiment, it is possible to suppress delays in traffic transmitted wirelessly. Details of the effects of the first embodiment will be described below.

In the wireless communication system, the rTWT function is known as a function for preferentially securing the transmission opportunity of low delay traffic. The access point AP using the rTWT function schedules an rTWT service period SP for causing the EHT terminal STA1 to transmit low delay traffic and the transmission suppression period QI for prohibiting transmission of traffic (data) by the legacy terminal STA2 not corresponding to the rTWT function so as to overlap each other. In a case where the transmission suppression period QI coincides with the length of the rTWT service period SP, the legacy terminal STA2 cannot transmit data in the rTWT service period SP even if the data is held in the transmission queue. Further, since contention operations for acquiring channel transmission rights are equally executed between the EHT terminal STA1 and the legacy terminal STA2 outside the rTWT service period SP, unfairness may occur in an acquisition opportunity of transmission rights.

Then, the communication system 1 according to the first embodiment sets the transmission suppression period RP for suppressing frame transmission for a fixed period to the EHT terminal STA1 after the end of the rTWT service period SP. By setting the transmission suppression period RP, the transmission opportunity to the legacy terminal STA2 which does not correspond to the rTWT function is secured. For example, the access point AP may set a length (period α) of the transmission suppression period RP based on a transmission period (uplink/downlink/bidirectional) used by a subordinate EHT terminal STA1 during the rTWT service period SP.

As a result, the legacy terminal STA2 which cannot communicate during the rTWT service period SP in the transmission suppression period RP can avoid competition for acquiring a channel access right with the EHT terminal STA1 which preferentially communicates during the rTWT service period SP. In other words, the communication system 1 according to the first embodiment can maintain fairness of transmission opportunities between the wireless terminal apparatus WTA using the rTWT function and the wireless terminal apparatus WTA not using the rTWT function, and can secure a traffic transmission opportunity by the legacy terminal STA2. Therefore, the communication system 1 according to the first embodiment can suppress delay of traffic transmitted wirelessly in each of the EHT terminal STA1 and the legacy terminal STA2.

In a case where the EHT terminal STA1 does not execute frame exchange in the rTWT service period SP, the transmission suppression period RP in the TWT interval TI can be omitted. In this case, the access point AP uses, for example, any of the second to fourth conditions described with reference to FIG. 13 for calculating the period α.

### <2> Second Embodiment

The communication system 1 according to a second embodiment sets a transmission suppression period RPa by transmitting a wireless frame that the access point AP instructs prohibition of transmission to an STA1 of a low delay group. Details of the communication system 1 according to the second embodiment will be described below.

### <2-1> Configuration

The hardware configuration of the communication system 1 according to the second embodiment is the same as the communication system 1 according to the first embodiment. The communication system 1 according to the second embodiment differs from the communication system 1 according to the first embodiment in the functional configuration of the access point AP.

### (Functional Configuration of Access Point APa)

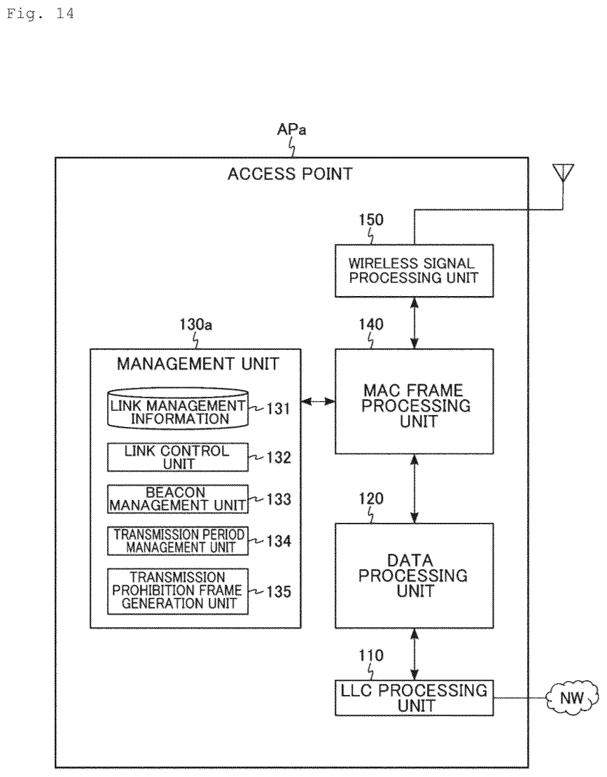

FIG. 14 is a block diagram illustrating an example of the functional configuration of an access point APa included in the communication system 1 according to the second embodiment. As illustrated in FIG. 14, the access point APa functions as a computer that includes the LLC processing unit 110, the data processing unit. 120, a management unit 130a, the MAC frame processing unit 140, and the wireless signal processing unit 150. The management unit 130a includes the link management information 131, the link control unit 132, the beacon management unit 133, the transmission period management unit 134, and a transmission prohibition frame generation unit 135.

The transmission prohibition frame generation unit 135 generates a transmission prohibition frame. The transmission prohibition frame is a high priority frame, for example, a trigger frame. The transmission prohibition frame instructs the wireless terminal apparatus WTA (EHT terminal STA1) communicating during the rTWT service period SP to prohibit frame exchange during a fixed period outside the rTWT service period SP. The fixed period is based on, for example, the period α calculated by the transmission period management unit 134. Then, the transmission prohibition frame generation unit 135 transmits the generated transmission prohibition frame to the EHT terminal STA1 via the MAC frame processing unit 140 and the wireless signal processing unit 150.

In the second embodiment, the transmission period management unit 134 may perform timer management after the transmission of the transmission prohibition frame by the transmission prohibition frame generation unit 135. The other functional configurations of the communication system 1 according to the second embodiment are the same as those of the communication system 1 according to the first embodiment.

### (Format of Prohibition Frame)

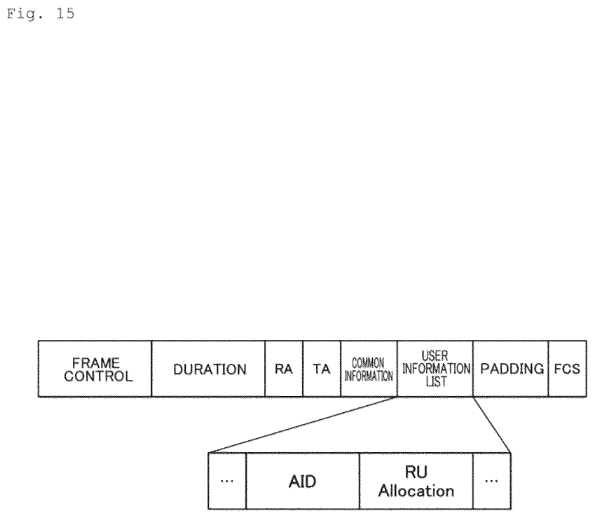

FIG. 15 is a schematic diagram illustrating an example of the format of a transmission prohibition frame transmitted by the access point APa included in the communication system 1 according to the second embodiment. FIG. 15 illustrates a case where the transmission prohibition frame is a trigger frame. As illustrated in FIG. 15, the plurality of fields included in the transmission prohibition frame include, for example, a frame control field, a duration field, address fields (RA and TA), a common information field, a user information list field, a padding field, and a frame check sequence (FCS) field.

The frame control field stores various control information. For example, the frame control field includes information indicating a frame type of the wireless frame. The duration field indicates the scheduled period of time during which the wireless line will be used. The address field indicates BSSID, transmission source address, destination address, sender terminal address, receiver terminal address, and the like. The common information field includes information indicating a type of a trigger frame or the like. The user information list field includes, for example, “AID” and “Resource Unit (RU) Allocation”. The wireless terminal apparatus WTA recognizes that the allocation is to its own station by the AID. The wireless terminal apparatus WTA recognizes the allocated resource by RU allocation. The padding is an area for adjusting a data length of a wireless frame. The FCS field stores an error detection code for the MAC header and frame body field, and is used to determine whether or not there is an error in the data frame.

In a case where the trigger frame is used as a transmission prohibition frame, allocation of a communication resource (frequency, transmission timing, or period) to the specific wireless terminal apparatus WTA is set to “0”. Thus, the communication of the specific wireless terminal apparatus WTA (EHT terminal STA1) is prohibited in a fixed period (transmission suppression period RPa). The transmission prohibition frame may be a frame (for example, an EHT action frame or a unique definition frame) that can be referred to in the wireless terminal apparatus WTA of the group sharing the rTWT service period SP.

### <2-2> Frame Exchange Method

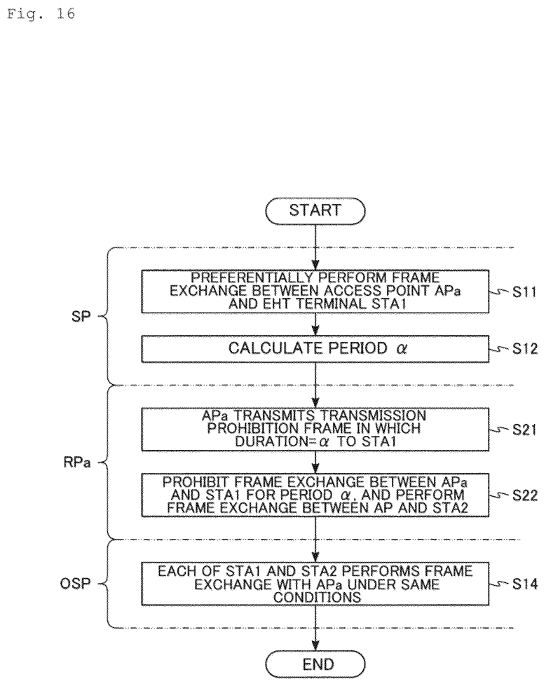

FIG. 16 is a flowchart illustrating an example of a frame exchange method using the rTWT function of the communication system 1 according to the second embodiment. Hereinafter, the frame exchange method using the rTWT function of the communication system 1 according to the second embodiment will be described with reference to FIG. 16 focusing on one TWT interval TI.

When the rTWT service period SP starts (starts), frame exchange is preferentially executed between the access point APa and the EHT terminal STA1, similarly to the access point AP of the first embodiment (S11).

When the frame exchange in the rTWT service period SP is completed, the access point APa calculates the period α in the same manner as the access point AP of the first embodiment (S12).

When the rTWT service period SP ends, the transmission suppression period RPa starts. Then, the access point APa transmits a transmission prohibition frame with the duration (continuation period of transmission suppression period RPa)=α to the EHT terminal STA1 to the EHT terminal STA1 (S21). Specifically, the transmission period management unit 134 notifies the transmission prohibition frame generation unit 135 of the period α for prohibiting the EHT terminal STA1 from frame exchange. Then, the transmission prohibition frame generation unit 135 generates a transmission prohibition frame in which the duration is set to duration=α based on the information notified to the transmission period management unit 134. Then, the transmission prohibition frame generation unit 135 transmits the generated transmission prohibition frame to the EHT terminal STA1 via the MAC frame processing unit 140 and the wireless signal processing unit 150. In other words, the EHT terminal STA1 that has received the transmission prohibition frame sets a network allocation vector (NAV: Transmission prohibition period) for the period α indicated by the duration value to suppress (prohibit) transmission.

Thus, in the transmission suppression period RPa, the frame exchange between the access point APa and the EHT terminal STA1 is prohibited for the period α, and the frame exchange is executed between the access point APa and the legacy terminal STA2 (S22).

When the transmission suppression period RPa ends, the period OSP starts. Then, each of the SET terminal STA1 and the legacy terminal STA2 executes frame exchange with the access point APa under the same conditions (S14) similarly to the first embodiment. When the period OSP ends (ends), the access point APa completes the series of processing procedures illustrated in FIG. 16, and starts the processing of the next rTWT service period SP.

The transmission timing of the transmission inhibition frame in the processing of S21 is, for example, the end time of the rTWT service period SP. The access point APa may cause the wireless signal processing unit 150 to transmit the transmission prohibition frame using the access category having the highest priority in order to transmit the transmission prohibition frame at the end time of the rTWT service period SP. Alternatively, the access point APa may transmit a transmission prohibition frame by preferential transmission means different from the access category.

### (Specific Example of Frame Exchange Method)

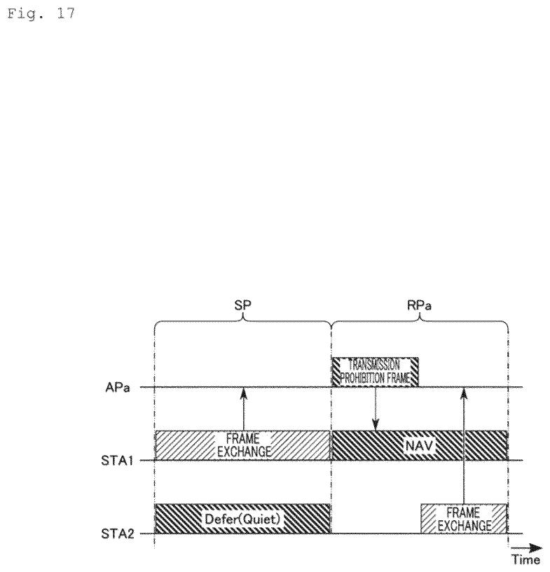

FIG. 17 is a diagram illustrating a specific example of a frame exchange method using the rTWT function of the communication system 1 according to the second embodiment. FIG. 17 illustrates the operation of the access point APa, the EHT terminal STA1, and the legacy terminal STA2 by extracting and displaying the rTWT service period SP and the transmission suppression period RPa included in one TWT interval TI.

As illustrated in FIG. 17, in the rTWT service period SP, frame exchange may be executed between the EHT terminal STA1 and the access point APa similarly to the first embodiment. Also, in the transmission suppression period QI set in the rTWT service period SP, the legacy terminal STA2 defers transmission of a frame, that is, waits (quiet).

When the rTWT service period SP ends, the access point APa transmits the transmission prohibition frame to the EHT terminal STA1. Then, NAV is set to the EHT terminal STA1 which has received the transmission prohibition frame. A period in which NAV is set in the ENT terminal STA1 corresponds to the transmission suppression period RPa. In the transmission suppression period RPa, the legacy terminal STA2 may execute frame exchange with the access point APa. Thus, in the transmission suppression period RPa, frame exchange between the legacy terminal STA2 and the access point APa is prioritized. Other operations of the communication system 1 according to the second embodiment are similar to those of the communication system 1 according to the first embodiment.

### <2-3> Effect of Second Embodiment

As described above, the communication system 1 according to the second embodiment sets the transmission suppression period RPa for suppressing the frame exchange by the EHT terminal STA1 based on the transmission prohibition frame. As a result, the communication system 1 according to the second embodiment can maintain fairness of transmission opportunities between the wireless terminal apparatus WTA using the rTWT function and the wireless terminal apparatus WTA not using the rTWT function. Therefore, the communication system 1 according to the second embodiment can suppress delay of traffic transmitted wirelessly in each of the EHT terminal STA1 and the legacy terminal STA2 similarly to the first embodiment.

### <3> Third Embodiment

In the communication system 1 according to a third embodiment, the EHT terminal STA1 uses a Request to Send (RTS)/Clear to Send (CTS) procedure, and the access point AP sets a transmission suppression period RPb by providing a period for omitting a response to the RTS of the EHT terminal STA1. Details of the communication system 1 according to the third embodiment will be described below.

### <3-1> Configuration

The hardware configuration of the communication system 1 according to the third embodiment is the same as the communication system 1 according to the first embodiment. The communication system 1 according to the third embodiment differs from the communication system 1 according to the first embodiment in the functional configuration of the access point AP.

### (Functional Configuration of Access Point APb)

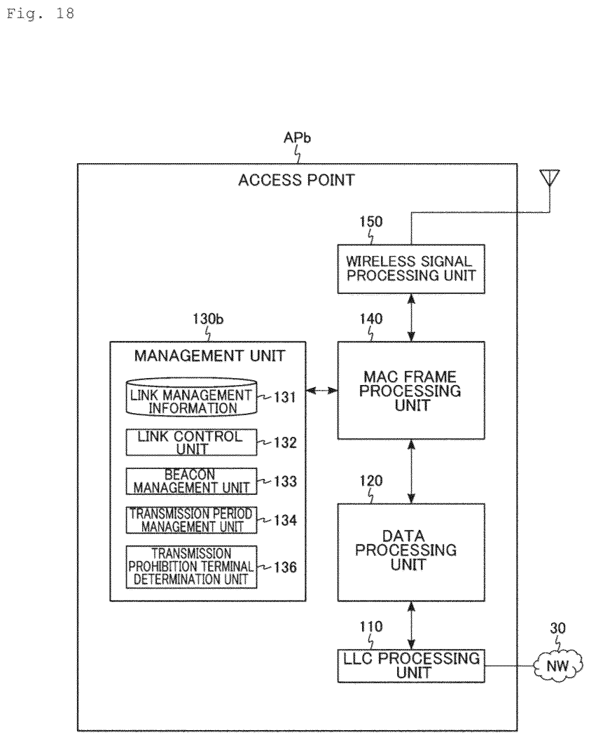

FIG. 18 is a block diagram illustrating an example of the functional configuration of the access point APb included in the communication system 1 according to the third embodiment. As illustrated in FIG. 18, the access point APb functions as a computer that includes the LLC processing unit 110, the data processing unit 120, a management unit 130b, the MAC frame processing unit 140, and the wireless signal processing unit 150. The management unit 130b includes the link management information 131, the link control unit 132, the beacon management unit 133, the transmission period management unit 134, and a transmission prohibition terminal determination unit 136.

The transmission prohibition terminal determination unit 136 confirms the type of the wireless terminal apparatus WTA that has transmitted the RTS received by the access point APb in the transmission suppression period RPb notified by the transmission period management unit 134. In a case where the RTS transmitted by the EHT terminal STA1 is received, the transmission prohibition terminal determination unit 136 omits a response of the CTS to the EHT terminal STA1. On the other hand, in a case where the RTS transmitted by the legacy terminal STA2 is received, the transmission prohibition terminal determination unit 136 causes the CTS to the legacy terminal STA2 to be transmitted via the MAC frame processing unit 140 and the wireless signal processing unit 150.

The management unit 130b may request the wireless terminal apparatus WTA (EHT terminal STA1) that has performed communication in the rTWT service period SP to use the RTS/CTS for transmission of uplink data in the transmission suppression period RPb following the rTWT service period SP. The transmission prohibition terminal determination unit 136 may return the CTS to the RTS of the EHT terminal STA1 and permit the EHT terminal STA1 to communicate in a case where there is a margin in the communication resource in the transmission suppression period RPb. In the transmission suppression period RPb following the rTWT service period SP, the RTS/CTS procedure is used only for a wireless terminal apparatus WTA (EHT terminal STA1) that has performed communication in the rTWT service period SP, and the legacy terminal STA2 may communicate with the access point APb without using an RTS/CTS means. The other functional configurations of the communication system 1 according to the third embodiment are the same as those of the communication system 1 according to the first embodiment.

### <3-2> Frame Exchange Method

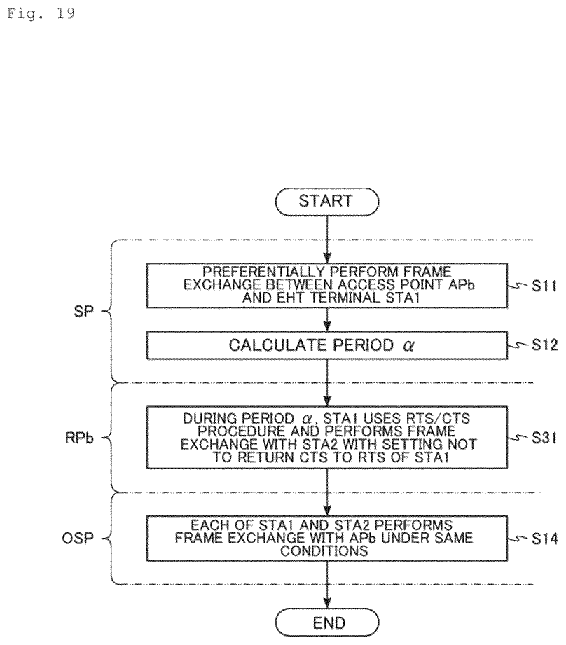

FIG. 19 is a flowchart illustrating an example of a frame exchange method using the rTWT function of the communication system 1 according to the third embodiment. Hereinafter, the frame exchange method using the rTWT function of the communication system 1 according to the first embodiment will be described with reference to FIG. 19 focusing on one TWT interval TI.

When the rTWT service period SP starts (starts), frame exchange is preferentially executed between the access point APb and the EHT terminal STA1 in the same manner as the access point AP of the first embodiment (S11).

When the frame exchange in the rTWT service period SP is completed, the access point APb calculates the period α in the same manner as the access point AP of the first embodiment (S12).

When the rTWT service period SP ends, the transmission suppression period RPb starts. Then, during the period α, the EHT terminal STA1 uses an RTS/CTS procedure, and the access point APb executes frame exchange with the legacy terminal STA2 with setting not to return the CTS to the RTS of the EHT terminal STA1 (S31).

When the transmission suppression period RPb ends, the period OSP starts. Then, the EHT terminal STA1 and the legacy terminal STA2 execute frame exchange with the access point APb under the same conditions as the access point AP of the first embodiment (S14). When the period OSP ends (ends), the access point APb completes the series of processing procedures illustrated in FIG. 19, and starts the processing of the next rTWT service period SP.

### (Specific Example of Frame Exchange Method)

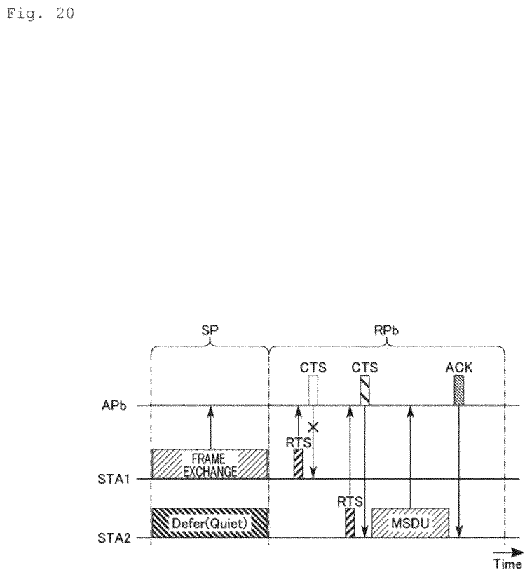

FIG. 20 is a time chart illustrating a specific example of a frame exchange method using the rTWT function of the communication system 1 according to the third embodiment. FIG. 20 illustrates the operation of the access point APb, the EHT terminal STA1, and the legacy terminal STA2 by extracting and displaying the rTWT service period SP and the transmission suppression period RPb included in one TWT interval TI.

As illustrated in FIG. 20, in the rTWT service period SP, frame exchange may be executed between the EHT terminal STA1 and the access point APb similarly to the first embodiment. Also, in the transmission suppression period QI set in the rTWT service period SP, the legacy terminal STA2 defers transmission of a frame, that is, waits (quiet).

When the rTWT service period SP ends, the access point APb sets the transmission suppression period RPb. In the transmission suppression period RPb, the EHT terminal STA1 may transmit the RTS to the access point APb according to a predetermined access parameter. However, the access point APb ignores RTS from the EHT terminal STA1 in the transmission suppression period RPb, and omits transmission of CTS to the EHT terminal STA1. On the other hand, the access point APb transmits the CTS to the RTS from the legacy terminal STA2 in the transmission suppression period RPb. Then, the legacy terminal STA2 receiving the CTS transmits data (MSDU) to the access point APb.

In this way, in the transmission suppression period RPb, the legacy terminal STA2 may execute the frame exchange with the access point APb. Therefore, in the transmission suppression period RPb, the frame exchange between the legacy terminal STA2 and the access point APb is prioritized.

The legacy terminal STA2 may communicate with the access point APb using means other than the RTS/CTS procedure in the transmission suppression period RPb. For example, the legacy terminal STA2, in the transmission suppression period RPb, uses the method described with reference to FIGS. 12 and 17, the frame exchange with the access point APb may be executed. Other operations of the communication system 1 according to the third embodiment are similar to those of the communication system 1 according to the first embodiment.

### <3-3> Effects of Third Embodiment

As described above, in the communication system 1 according to the third embodiment, the access point APb determines the wireless terminal apparatus WTA to be frame-exchanged, thereby setting the transmission suppression period RPb for suppressing frame exchange by the EHT terminal STA1. As a result, the communication system 1 according to the third embodiment can maintain fairness of transmission opportunities with the wireless terminal apparatus WTA that does not use the rTWT function. Therefore, the communication system 1 according to the third embodiment can suppress delay of traffic transmitted wirelessly in each of the EHT terminal STA1 and the legacy terminal STA2 similarly to the first embodiment.

In the transmission suppression period RPb, a response of the CTS to the RTS transmitted from the EHT terminal STA1 that has executed the frame exchange during the rTWT service period SP may be permitted. In this case, the response frequency of the CTS to the RTS in the transmission suppression period RPb is set lower in the EHT terminal. STA1 than in the legacy terminal STA2.

### <4> Fourth Embodiment

The communication system 1 according to a fourth embodiment sets a transmission suppression period RPc using an access parameter of low priority for transmission of uplink data in a period in which the EHT terminal STA1 is notified from the access point AP. Details of the communication system 1 according to the fourth embodiment will be described below.

### <4-1> Configuration

The hardware configuration of the communication system 1 according to the fourth embodiment is the same as the communication system 1 according to the first embodiment. The communication system 1 according to the fourth embodiment differs from the communication system 1 according to the first embodiment in the function configuration of the access point AP and the wireless terminal apparatus WTA.

### (Functional Configuration of Access Point APc)

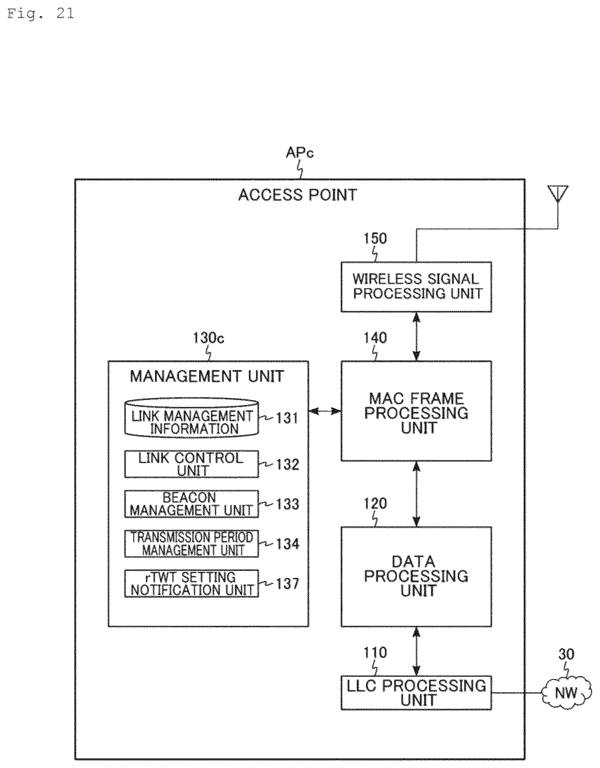

FIG. 21 is a block diagram illustrating an example of the functional configuration of an access point APc included in the communication system 1 according to the fourth embodiment. As illustrated in FIG. 21, the access point AP functions as a computer that includes the LLC processing unit 110, the data processing unit 120, a management unit 130c, the MAC frame processing unit 140, and the wireless signal processing unit 150. The management unit 130c includes the link management information 131, the link control unit 132, the beacon management unit 133, the transmission period management unit 134, and an rTWT setting notification unit 137.

The rTWT setting notification unit 137 manages a parameter to be set to the EHT terminal STA1 in the transmission suppression period RPc. Then, the rTWT setting notification unit 137 notifies the EHT terminal STA1 of the parameter by a predetermined method. The predetermined method may generate a control frame including a parameter and transmit the control frame to the EHT terminal STA1, or may cause the beacon management unit 133 to transmit a beacon including the parameter. This parameter is a parameter arbitrarily determined by the access point APc, for example, an access parameter such as an AIPS and a CW for determining a backoff value. In the transmission suppression period RPc, an access parameter applied to the EHT terminal STA1 is set to be a condition disadvantageous to a wireless terminal apparatus WTA not communicating during an rTWT service period SP, and to be lower priority than an access parameter set to the wireless terminal apparatus WTA during the period OSP.

(Functional Configuration of Wireless terminal Apparatus WTAa)

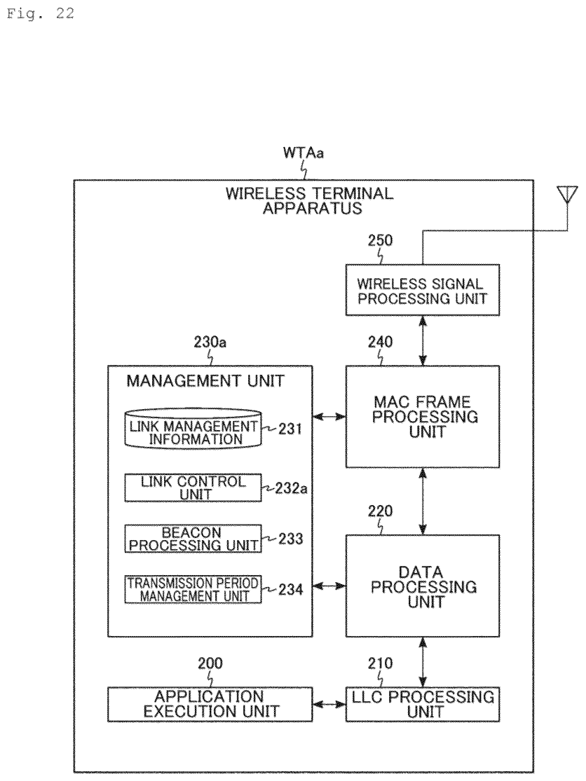

FIG. 22 is a block diagram illustrating an example of the functional configuration of a wireless terminal apparatus WTAa included in the communication system 1 according to the fourth embodiment. As illustrated in FIG. 22, the wireless terminal apparatus WTAa includes, for example, the application execution unit 200, the LLC processing unit 210, the data processing unit 220, a management unit 230a, the MAC frame processing unit 240, and the wireless signal processing unit 250. The management unit 230a includes, for example, the link management information 231, a link control unit 232a, the beacon processing unit 233, and a transmission period management unit 234.

The transmission period management unit 234 manages information on the transmission suppression period RPc notified from the access point APc and an access parameter of the EHT terminal STA1 applied during the transmission suppression period RPc. The transmission period management unit 234 instructs the change of the access parameter of the link control unit 232a in the transmission suppression period RPc based on the management information of the rTWT function recorded in the link management information 231. The link control unit 232a changes the access parameter in the transmission suppression period RPc based on the instruction of the transmission period management unit 234. In other words, the transmission period management unit 234 causes the link control unit 232a to change a parameter for acquiring a channel transmission right based on information on the transmission suppression period RPc notified from the access point APc. The other functional configurations of the communication system 1 according to the fourth embodiment are the same as those of the communication system 1 according to the first embodiment.

### <4-2> Frame Exchange Method

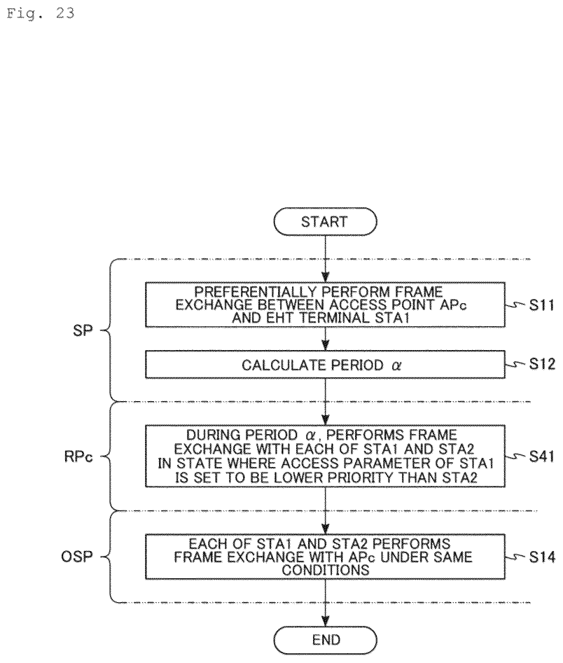

FIG. 23 is a flowchart illustrating an example of a frame exchange method using the rTWT function of the communication system according to the fourth embodiment. Hereinafter, the frame exchange method using the rTWT function of the communication system 1 according to the fourth embodiment will be described with reference to FIG. 23 focusing on one TWT interval TI.

When the rTWT service period SP starts (starts), the frame exchange is preferentially executed between the access point APc and the EHT terminal STA1 similarly to the access point AP of the first embodiment (S11).

When the frame exchange in the rTWT service period SP is completed, the access point APc calculates the period α in the same manner as the access point AP of the first embodiment (S12).

When the rTWT service period SP ends, the transmission suppression period RPc starts. During the period α, the frame exchange with each of the EHT terminal STA1 and the legacy terminal STA2 is executed in a state where the access parameter of the EHT terminal STA1 is set to be lower priority than the legacy terminal STA2 (S41). That is, in the transmission suppression period RPC, an access parameter which is more advantageous to a legacy terminal STA2 which does not execute frame exchange than the EHT terminal STA1 which executes frame exchange in the rTWT service period SP is applied. Thus, in the transmission suppression period RPc, the legacy terminal STA2 can acquire a channel transmission right more easily than an EHT terminal STA1 that has performed communication during the rTWT service period SP. In the processing of S41, the access point APc may set the access parameter of the EHT terminal STA1 which has not executed frame exchange in the immediately preceding rTWT service period SP to the same priority as that of the legacy terminal STA2.

When the transmission suppression period RPc ends, the period OSP starts. Then, the EHT terminal STA1 and the legacy terminal STA2 execute the frame exchange with the access point APc under the same conditions as the access point AP of the first embodiment (S14). When the period OSP ends (ends), the access point APc completes the series of processing procedures illustrated in FIG. 23, and starts the processing of the next rTWT service period SP.

The access point APc can notify the EHT terminal STA1 terminal of an access parameter to be temporarily applied in the transmission suppression period RPc by a control frame to be sequentially transmitted. The access parameter temporarily applied in the transmission suppression period RPc may be notified to the EHT terminal STA1 at the time of setting up of the rTWT function (for example, processing of S7 in FIG. 9). That is, the access point APc may transmit a frame including an access parameter temporarily applied in the transmission suppression period RPc to the EHT terminal STA1 before the start of the transmission suppression period RPc.

As described above, the EHT terminal STA1 in the fourth embodiment can receive first information including the information of the periodic rTWT service period SP from the access point APc and transmit the data in the rTWT service period SP. Then, the EHT terminal STA1 receives second information including information on a transmission suppression period RPc outside the rTWT service period SP from the access point APc, and can suppress or prohibit transmission of data in the transmission suppression period RPc.

### (Specific Example of Frame Exchange Method)

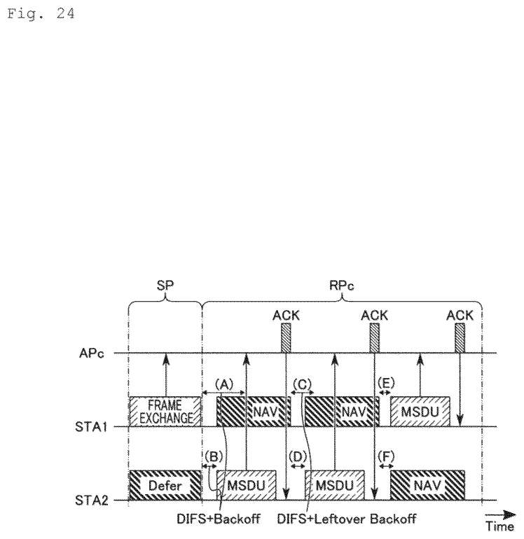

FIG. 24 is a time chart illustrating a specific example of a frame exchange method using the rTWT function of the communication system according to the fourth embodiment. FIG. 24 illustrates the operation of the access point APc, the ET terminal STA1, and the legacy terminal STA2 by extracting and displaying the rTWT service period SP and the transmission suppression period RPc included in one TWT interval TI.

As illustrated in FIG. 24, in the rTWT service period SP, the frame exchange may be executed between the EHT terminal STA1 and the access point APc, as in the access point AP of the first embodiment. In addition, the transmission suppression period QI set in the rTWT service period SP, the legacy terminal STA2 defers frame transmission.

When the rTWT service period SP ends, the transmission suppression period RPc preset between the access point APc and the EHT terminal STA1 starts. In the transmission suppression period RPc, the EHT terminal STA1 tries to acquire the transmission right according to an access parameter lower in priority than the legacy terminal STA2. On the other hand, the legacy terminal STA2 tries to acquire the transmission right according to an access parameter having higher priority than the EHT terminal STA1. Thus, in the transmission suppression period RPc, the legacy terminal STA2 can acquire the transmission right more easily than the EHT terminal STA1.

Specifically, when the transmission suppression period RPc starts, a count (A) of DIFS+backoff of the EHT terminal STA1 and a count (B) of DIFS+backoff of the legacy terminal STA2 start, respectively. Then, since the numerical value of the backoff of the EHT terminal STA1 is set larger than the numerical value of the backoff of the legacy terminal STA2, the legacy terminal STA2 first obtains the transmission right and transmits the MSDU to the access point APc. The EHT terminal STA1 is set to NAV while the legacy terminal STA2 performs frame exchange with the access point APc.

When a confirmation frame ACK based on the transmission completion of the MSDU is transmitted, a count (C) of DIFS+leftover backoff of the EHT terminal STA1 and a count (D) of DIFS+backoff of the legacy terminal STA2 start, respectively. In this example, since the numerical value of the leftover backoff of the EHT terminal STA1 is larger than the numerical value of the backoff of the legacy terminal STA2, the legacy terminal STA2 obtains the transmission right again, and transmits the MSDU to the access point APc. The EHT terminal STA1 is set to the NAV while the legacy terminal STA2 performs frame exchange with the access point APc.

When the confirmation frame ACK based on the transmission completion of the MSDU is transmitted, a count (E) of DIFS+leftover backoff of the EHT terminal STA1 and a count (F) of DIFS+backoff of the legacy terminal STA2 start, respectively. In this example, since the numerical value of the leftover backoff of the EHT terminal STA1 becomes smaller than the numerical value of the backoff of the legacy terminal STA2, the EHT terminal STA1 obtains the transmission right and transmits the MSDU to the access point APc. The legacy terminal STA2 is set to NAV while the EHT terminal STA1 performs frame exchange with the access point APc.

As described above, in the transmission suppression period RPc, the frequency of frame exchange between the legacy terminal STA2 and the access point APc becomes higher than that between the EHT terminal STA1 and the access point APc. That is, in the transmission suppression period RPc, the frame exchange of the legacy terminal STA2 is performed with priority. The low priority setting of the access parameter may be realized by other parameters instead of the magnitude of the backoff value. Other operations of the communication system 1 according to the fourth embodiment are similar to those of the communication system 1 according to the first embodiment.

### <4-3> Effect of Fourth Embodiment

As described above, in the communication system 1 according to the fourth embodiment, the EHT terminal STA1 sets the transmission suppression period RPc for suppressing frame exchange by the EHT terminal STA1 by lowering the priority of the access parameter after the rTWT service period SP. As a result, the communication system 1 according to the fourth embodiment can maintain fairness of transmission opportunities with the wireless terminal apparatus WTA that does not use the rTWT function. Therefore, the communication system 1 according to the fourth embodiment can suppress delay of traffic transmitted wirelessly in each of the EHT terminal STA1 and the legacy terminal STA2 similarly to the first embodiment.

In the fourth embodiment, a case has been described in which the access parameter (EDCA parameter) is set to low priority in order to reduce the transmission frequency of the ENT terminal STA1 during the transmission suppression period RPC, the present invention is not limited to this. Instead of the access parameter, a parameter arbitrarily determined by the access point APc may be used. In the fourth embodiment, the EHT terminal STA1 may communicate with a setting lower in priority than the legacy terminal STA2 based on a parameter arbitrarily determined by the access point APc in the transmission suppression period RPc.

### <5> Fifth Embodiment

The communication system 1 according to a fifth embodiment sets a transmission suppression period RPd by prohibiting frame exchange in a period notified from the access point AP by the EHT terminal STA1. Details of the communication system 1 according to the fifth embodiment will be explained below.

### <5-1> Configuration

The hardware configuration of the communication system 1 according to the fifth embodiment is the same as the communication system 1 according to the fourth embodiment. The communication system 1 according to the fifth embodiment differs from the communication system 1 according to the fourth embodiment in the functional configuration of the wireless terminal apparatus WTA.

### (Functional Configuration of Wireless Terminal Apparatus WTA)

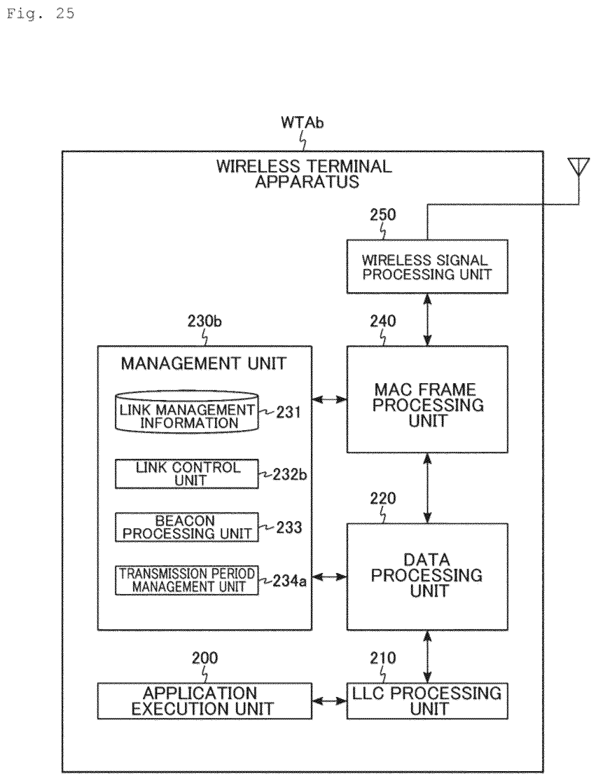

FIG. 25 is a block diagram illustrating an example of the functional configuration of the wireless terminal apparatus WTAb included in the communication system 1 according to the fifth embodiment. As illustrated in FIG. 22, the wireless terminal apparatus WTAb includes, for example, the application execution unit 200, the LLC processing unit 210, the data processing unit 220, the management unit 230b, the MAC frame processing unit 240, and the wireless signal processing unit 250. The management unit 230b includes, for example, link management information 231, a link control unit 232b, the beacon processing unit 233, and a transmission period management unit 234a.

The transmission period management unit 234a manages information of the transmission suppression period RPd notified from the access point APc. The transmission period management unit 234a notifies the link control unit 232b of the transmission suppression period RPd based on the management information of the rTWT function recorded in the link management information 231. The link control unit 232b suppresses (prohibits) frame exchange in the transmission suppression period RPd of the EHT terminal STA1 based on an instruction of the transmission period management unit. 234a. The transmission period management unit 234a may perform timer management of the operation of the transmission suppression period RPd by the link control unit 232b. The other functional configurations of the communication system 1 according to the fifth embodiment are the same as those of the communication system 1 according to the fourth embodiment.

### <5-2> Frame Exchange Method

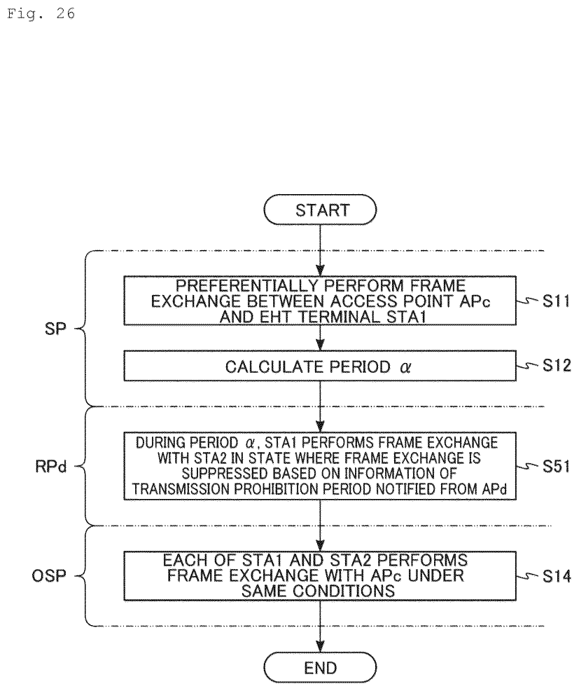

FIG. 26 is a flowchart illustrating an example of a frame exchange method using the rTWT function of the communication system 1 according to the fifth embodiment. Hereinafter, the frame exchange method using the rTWT function of the communication system 1 according to the fifth embodiment will be described with reference to FIG. 26 focusing on one TWT interval TI.

When the rTWT service period SP starts (starts), the frame exchange is preferentially executed between the access point APc and the EHT terminal STA1 similarly to the access point AP of the first embodiment (S11).

When the frame exchange in the rTWT service period SP is completed, the access point APc calculates the period α in the same manner as the access point AP of the first embodiment (S12).

When the rTWT service period SP ends, the transmission suppression period RPd starts. Then, during the period α, the access point APc executes frame exchange with the legacy terminal STA2 in a state where the EHT terminal STA1 suppresses the frame exchange based on the information of the transmission suppression period RPd notified from the access point APc (S51). The access point APc can notify the EFT terminal STA1 terminal of the period α to be applied to the transmission suppression period RPd by a control frame to be sequentially transmitted. The period α may be set based on the statistical value and notified to the EMT terminal STA1 when the rTWT function is set up.

When the transmission suppression period RPd ends, the period OSP starts. Then, each of the EHT terminal STA1 and the legacy terminal STA2 executes frame exchange with the access point APc under the same conditions (S14) similarly to the first embodiment. When the period OSP ends (ends), the access point APc completes the series of processing procedures illustrated in FIG. 26, and starts the processing of the next rTWT service period SP.

### (Specific Example of Frame Exchange Method)

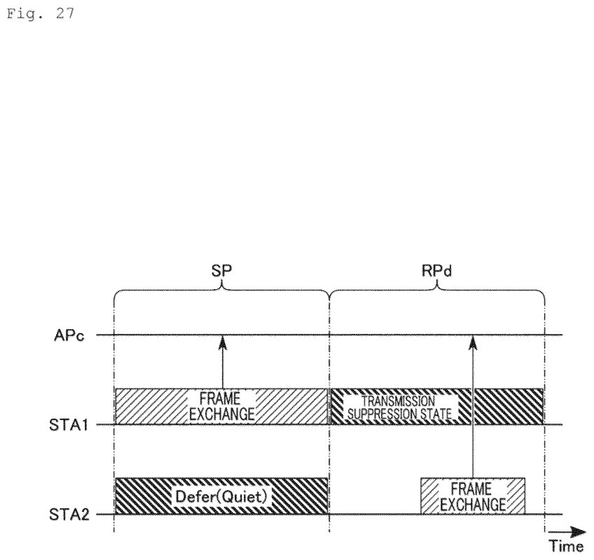

FIG. 27 is a time chart illustrating a specific example of a frame exchange method using the rTWT function of the communication system 1 according to the fifth embodiment. FIG. 27 illustrates the operation of the access point APc, the EHT terminal STA1, and the legacy terminal STA2 by extracting and displaying the rTWT service period SP and the transmission suppression period RPd included in one TWT interval TI.

As illustrated in FIG. 27, in the rTWT service period SP, the frame exchange may be performed between the EHT terminal STA1 and the access point APc similarly to the first embodiment. Also, in the transmission suppression period QI set in the rTWT service period SP, the legacy terminal STA2 defers transmission of a frame, that is, waits (quiet).

When the rTWT service period SP ends, the EHT terminal STA1 spontaneously enters a transmission suppression state (for example, NAV) based on the transmission suppression period RPd previously notified from the access point APc. On the other hand, the legacy terminal STA2 may perform frame exchange with the access point APc in the transmission suppression period RPd. Therefore, in the transmission suppression period RPd, the frame exchange between the legacy terminal STA2 and the access point APc is prioritized. Other operations of the communication system 1 according to the fifth embodiment are similar to those of the communication system 1 according to the fourth embodiment.

### <5-3> Effect of Fifth Embodiment

As described above, in the communication system 1 according to the fifth embodiment, the EHT terminal STA1 spontaneously suppresses the frame exchange after the rTWT service period SP, thereby setting the transmission suppression period RPd. As a result, the communication system 1 according to the fifth embodiment can maintain fairness of transmission opportunities between the wireless terminal apparatus WTA using the rTWT function and the wireless terminal apparatus WTA not using the rTWT function. Therefore, the communication system 1 according to the fifth embodiment can suppress delay of traffic transmitted wirelessly in each of the EHT terminal STA1 and the legacy terminal STA2 similarly to the first embodiment.

### <6> Others

In the above embodiment, the case where the access point AP calculates the period α of the transmission suppression period RP based on the communication performance within the rTWT service period SP in one period of the TWT period (TWT interval TI) has been described. However, it is not limited thereto. The access point AP may calculate the period α based on statistics of communication results of a plurality of rTWT service periods SP. In the above embodiment, the transmission suppression period RP is set immediately after the rTWT service period SP, but the rTWT service period SP and the transmission suppression period RP may be separated from each other. In a case where the transmission suppression period RP is set based on a communication result of the latest rTWT service period SP, the transmission suppression period RP is set after the rTWT service period SP.

The access point AP may establish a multi-link with the wireless terminal apparatus WTA using a plurality of channels. Each of the access point AP and the wireless terminal apparatus WTA may include a plurality of wireless signal processing units (STA functions) corresponding to a plurality of channels, respectively. In a case where a multi-link is established, a multi-link association request and a multi-link association process are respectively executed in place of the processing in S3 and S4 illustrated in FIG. 9 using any of a plurality of STA functions. When establishing the multi-link, authentication and association processing of other links constituting the multi-link may be executed using one link in which the link with the access point AP is established first. The communication system 1 may dynamically determine in which link the frame exchange is to be performed every rTWT service period SP in a case of using the multi-link. In the multi-link, one or more STA functions may be allocated to one traffic identifier. For example, the association between traffic and STA functions is set so that the traffic volume (data volume) is even among a plurality of links constituting the multi-link. The present invention is not limited thereto and similar types of traffic (priority/non-priority or the like) may be collected in a specific link constituting the multi-links.

In the information communication system 1 according to the embodiment, each of the CPU 11 included in the access point AP and the CPU 21 included in the wireless terminal apparatus WTA may be other circuits. For example, each of the access point AP and the wireless terminal apparatus WTA may include a micro processing unit (MPU) or the like instead of the CPU. Each of the steps of processing described in the embodiments may be implemented by dedicated hardware. Each of processing of the access point AP and the wireless terminal apparatus WTA may include a mixture of processing procedures executed by software and processing procedures executed by hardware, or may include only one of them. The set of the data processing unit 120, the management unit 130, and the MAC frame processing unit 140 included in the access point AP may be called a “link management unit”. Similarly, a set of the data processing unit 220, the management unit 230, and the MAC frame processing unit 240 included in the wireless terminal apparatus WTA may be called a “link management unit”.

In the embodiment, the flowcharts used to describe the operations are merely examples. Each operation described in the embodiments may be replaced within a range in which the order of the processing can be fulfilled, or other processing may be added. For example, the link setup method described in the first embodiment is merely an example. Furthermore, the format of the radio frame described in the first embodiment is merely an example. Other formats may be used in the information communication system 1 as long as the operations described in the embodiments can be performed. A wireless communication standard different from the IEEE802.11 standard may be used for wireless communication between the access point AP and the wireless terminal apparatus WTA.

The present invention is not limited to the embodiments described above and can be modified in various ways without departing from the gist of the present invention at an execution stage. In addition, each of the embodiments may be combined appropriately, and in such a case, advantageous effects of the combinations can be obtained. Further, the foregoing embodiments include various inventions, and various inventions can be extracted by selecting combinations of the plurality of constituent elements disclosed herein. For example, even if several constituent elements are removed from all the constituent elements described in the embodiments, configurations in which those constituent elements are removed can be extracted as an invention as long as the problem can be solved and the advantageous effects can be obtained.

### REFERENCE SIGNS LIST

1 Communication system
AP Access point
11 CPU
12 ROM
13 RAM
14 Wireless communication module
15 Wired communication module
110 LLC processing unit
120 Data processing unit
130 Management unit
131 Link management information
132 Link control unit
133 Beacon management unit
134 Transmission period management unit
135 Transmission prohibition frame generation unit
136 Transmission prohibition terminal determination unit
137 rTWT setting notification unit
140 MAC frame processing unit
150 Wireless signal processing unit
151 Classification unit
152 Queue
153 Career sense execution unit
154 internal collision management unit
WTA Wireless terminal apparatus
21 CPU
22 ROM
23 RAM
24 Wireless communication module
25 Display
26 Storage
200 Application execution unit
210 LLC processing unit
220 Data processing unit
230 Management unit
231 Link management information
232 Link control unit
233 Beacon processing unit
234 Transmission period management unit
240 MAC frame processing unit
250 Wireless signal processing unit
STA1 EHT Terminal
STA2 Legacy terminal

1. An access point comprising:
a first wireless signal processing unit; and
a first management unit configured to establish a first link with a first wireless terminal apparatus and a second link with a second wireless terminal apparatus using the first wireless signal processing unit and sets a service period in a first cycle, wherein
the first management unit is configured to provide a transmission opportunity for data to the first wireless terminal apparatus, and suppress or prohibit transmission of data by the second wireless terminal apparatus within the service period, and set a transmission suppression period in which transmission of data by the first wireless terminal apparatus is suppressed or prohibited outside the service period.

2. The access point according to claim 1, wherein the first management unit is configured to transmit a first frame instructing prohibition of data transmission in the transmission suppression period to the first wireless terminal apparatus using the wireless signal processing unit at the start of the transmission suppression period.

3. The access point according to claim 1, wherein the first management unit is configured not to transmit a Clear to Send (CTS) for a Request to Send (RTS) received from the first wireless terminal apparatus during the transmission suppression period.

4. The access point according to claim 1, wherein the first management unit is configured to set a length of the transmission suppression period based on a length of the service period or a length of a period of frame exchange with the first wireless terminal apparatus executed within the service period.

5. The access point according to claim 1, wherein the first management unit transmits a second frame including information on the transmission suppression period to the first wireless terminal apparatus using the first wireless signal processing unit before the transmission suppression period starts.

6. A communication system comprising:
the access point according to claim 5; and
the first wireless terminal apparatus, wherein
the first wireless terminal apparatus includes a second wireless signal processing unit and a second management unit configured to establish the first link using the second wireless signal processing unit and manage a state of the first link, and
the second management unit is configured to set an access parameter of the first link in the transmission suppression period to a lower priority than an access parameter of the first link outside of the service period and outside of the transmission suppression period based on the information included in the second frame received by the first wireless terminal apparatus.

7. A communication system comprising:
the access point according to claim 5; and
the first wireless terminal apparatus, wherein
the first wireless terminal apparatus includes a second wireless signal processing unit and a second management unit configured to establish the first link using the second wireless signal processing unit and manage a state of the first link, and
the second management unit is configured to prohibit transmission of data transmission using the first link in the transmission suppression period based on the information included in the second frame received by the first wireless terminal apparatus.

8. A wireless terminal apparatus comprising:
a wireless signal processing unit; and
a management unit configured to establish a link with an access point using the wireless signal processing unit and manages a state of the link, wherein
the management unit is configured to:
receive first information including information on a periodic service period from the access point, and transmits data using the link in the service period, and
receive second information including information on a transmission suppression period outside the service period from the access point, and suppress or prohibit transmission of data using the link in the transmission suppression period.

9. The wireless terminal apparatus according to claim 8, wherein the management unit is configured to set an access parameter of the link in the transmission suppression period to a lower priority than an access parameter of the link outside of the service period and outside of the transmission suppression period based on the second information.

10. The wireless terminal apparatus according to claim 8, wherein the management unit is configured to prohibit data transmission using the link in the transmission suppression period based on the second information.
